(19) United States
(12) Patent Application Publication
(10) Pub. No.: US 2010/0153065 A1
(43) Pub. Date: Jun. 17, 2010

(54) INFORMATION PROCESSING DEVICE, INFORMATION PROCESSING METHOD AND PROGRAM

(75) Inventors: Kazuhiro KAWAMURA, Sapporo-shi (JP); Tsuyoshi Moriya, Nirasaki-shi (JP); Yasutoshi Umehara, Sapporo-shi (JP)

Correspondence Address: Ditthavong Mori & Steiner, P.C., 918 Prince Street, Alexandria, VA, 22314, US

(73) Assignee: TOKYO ELECTRON LIMITED, Tokyo (JP)

(21) Appl. No.: 12/711,255

(22) Filed: Feb. 24, 2010

Related U.S. Application Data
(63) Continuation of application No. PCT/JP2008/066233, filed on Sep. 9, 2008.

(30) Foreign Application Priority Data
Sep. 11, 2007 (JP) 2007-234843

(51) Int. Cl. G06F 15/00; G06F 17/18

(52) U.S. Cl. 702/179; 702/189; 702/190

(57) ABSTRACT

An information processing device includes a first input receiving unit, a second input receiving unit, a window function processing unit, a correlation calculating unit, and an output unit. The first input receiving unit is configured to receive first information including a first time-series data related to a semiconductor process. The second input receiving unit is configured to receive second information including a second time-series data related to the semiconductor process. The window function processing unit is configured to retrieve window acquiring information from the first information during an intended period using a window function. The correlation calculating unit is configured to calculate a cross-correlation function between the window acquiring information retrieved by the window function processing unit and the second information. The output unit is configured to output information corresponding to the cross-correlation function calculated by the correlation calculating unit.

### CROSS-REFERENCE TO RELATED APPLICATIONS

The present application is a continuation application of International Patent Application No. PCT/JP2008/66233 filed Sep. 9, 2008, which claims priority to Japanese Patent Application No. 2007-234843, filed Sep. 11, 2007. The contents of these applications are incorporated herein by reference in their entirety.

### BACKGROUND OF THE INVENTION

1. Field of the Invention

The present invention relates to an information processing device, an information processing method, and a program.

2. Discussion of the Background

A method of automatically and accurately processing data sent from a measurement instrument is conventionally known as a method of processing measurement data and the like related to the semiconductor process (see, e.g., Japanese Unexamined Patent Publication No. 11-354395, for example, page 1, FIG. 1, etc.). The measurement data processing method registers in advance a calculating formula for processing the measurement data, stores such measurement data in a measurement data receive buffer when receiving the measurement data, selects the calculating formula having at least the same recipe name suited for processing the measurement data from the registered calculating formula based on the recipe name of the measurement data and storing the same in a calculating formula storage buffer, applies the stored measurement data to the calculating formula to calculate, and stores the calculation result in a processed data storage buffer.

The abnormality in the semiconductor manufacturing process can be generally detected by monitoring the time-series data such as waveform of the measurement data and the like with eyes.

However, automating abnormality detection in time-series data in an information processing device and the like, and detecting a state of a semiconductor manufacturing apparatus at satisfactory accuracy are very difficult. For example, measurement data such as waveform data may contain a noise and the like, and variations in the waveform due to variations in the control of the process, fluctuation of external environment, and the like often occur. If the waveform and the like contain noise, variations in waveform, and the like, whether the entire reference data, which is the measurement data at the time of execution of the semiconductor process for the normal case prepared in advance and for the abnormal case, and the entire target data, which is the measurement data at the time of execution of the actual semiconductor process to be determined are coincident is difficult to detect at satisfactory accuracy if they are simply compared side by side. Therefore, it is difficult to determine whether or not the reference data and the target data are coincident, and determine whether or not the semiconductor process is normal.

### SUMMARY OF THE INVENTION

According to one aspect of the present invention, an information processing device includes a first input receiving unit, a second input receiving unit, a window function processing unit, a correlation calculating unit, and an output unit. The first input receiving unit is configured to receive first information including a first time-series data related to a semiconductor process. The second input receiving unit is configured to receive second information including a second time-series data related to the semiconductor process. The window function processing unit is configured to retrieve window acquiring information from the first information during an intended period using a window function. The correlation calculating unit is configured to calculate a cross-correlation function between the window acquiring information retrieved by the window function processing unit and the second information. The output unit is configured to output information corresponding to the cross-correlation function calculated by the correlation calculating unit.

According to another aspect of the present invention, an information processing method includes receiving first information including a first time-series data related to a semiconductor process and receiving second information including a second time-series data related to the semiconductor process. Window acquiring information is retrieved from the first information during an intended period using a window function. A cross-correlation function between the window acquiring information and the second information is calculated. Information corresponding to the cross-correlation function is outputted.

According to further aspect of the present invention, a program is configured to cause a computer to perform a process. The process includes receiving first information including a first time-series data related to a semiconductor process and receiving second information including a second time-series data related to the semiconductor process. Window acquiring information is retrieved from the first information during a intended period using a window function. A cross-correlation function between the window acquiring information and the second information is calculated. Information corresponding to the cross-correlation function is outputted.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawings, wherein:

FIG. 1 is a block diagram of an information processing device according to a first embodiment of the present invention;

FIG. 2 is a conceptual view of a semiconductor manufacturing apparatus management system equipped with the information processing device;

FIG. 3 is a view showing one example of a manufacturing apparatus in the semiconductor manufacturing apparatus management system;

FIG. 4 is a view describing a filtering process of the information processing device;

FIG. 5 is a view describing a filtering process of the information processing device;

FIG. 6 is a view describing a filtering process of the information processing device;

FIG. 7 is a flowchart describing an operation of the information processing device;

FIG. 8 is a view showing a display example of information in the information processing device;

FIG. 9 is a view showing a display example of information in the information processing device;

FIG. 10 is a view showing a display example of information in the information processing device;

FIG. 11 is a view showing a display example of information in the information processing device;

FIG. 12 is a view showing a display example of the information processing device;

FIG. 13 is a view showing a display example of information in the information processing device;

FIG. 14 is a view showing a display example of information in the information processing device;

FIG. 15 is a view showing a display example of information in the information processing device;

FIG. 16 is a view showing a display example of information in the information processing device;

FIG. 17 is a view showing a display example of information in the information processing device;

FIG. 18 is a view showing a display example of information in the information processing device;

FIG. 19 is a view showing a display example of information in the information processing device;

FIG. 20 is a schematic view showing one example of an outer appearance of a computer system for realizing the information processing device according to an embodiment of the present invention;

FIG. 21 is a view showing one example of a configuration of the computer system for realizing the information processing device according to an embodiment of the present invention;

FIG. 22 is a block diagram of the information processing device according to a second embodiment of the present invention;

FIG. 23 is a flowchart describing an operation of the information processing device;

FIG. 24 is a view showing an outline of a configuration of the information processing device;

FIG. 25 is a view showing a display example of information of the information processing device;

FIG. 26 is a view showing a display example of information of the information processing device;

FIG. 27 is a view showing a display example of the information processing device;

FIG. 28 is a view showing a display example of information of the information processing device;

FIG. 29 is a block diagram showing an information processing device according to a third embodiment of the present invention;

FIG. 30 is a flowchart describing an operation of the information processing device;

FIG. 31 is a flowchart describing an operation of the information processing device;

FIG. 32 is a view showing one example of period specifying information for describing the operation of the information processing device;

FIG. 33 is a view showing a display example of the information of the information processing device; and

FIG. 34 is a view showing a display example of the information processing device.

### DESCRIPTION OF THE EMBODIMENTS

Hereinafter, embodiments of the information processing device and the like will be described with reference to the drawings. Components denoted with the same reference numeral perform similar operations in the embodiments, and thus redundant description may not be given.

### First Embodiment

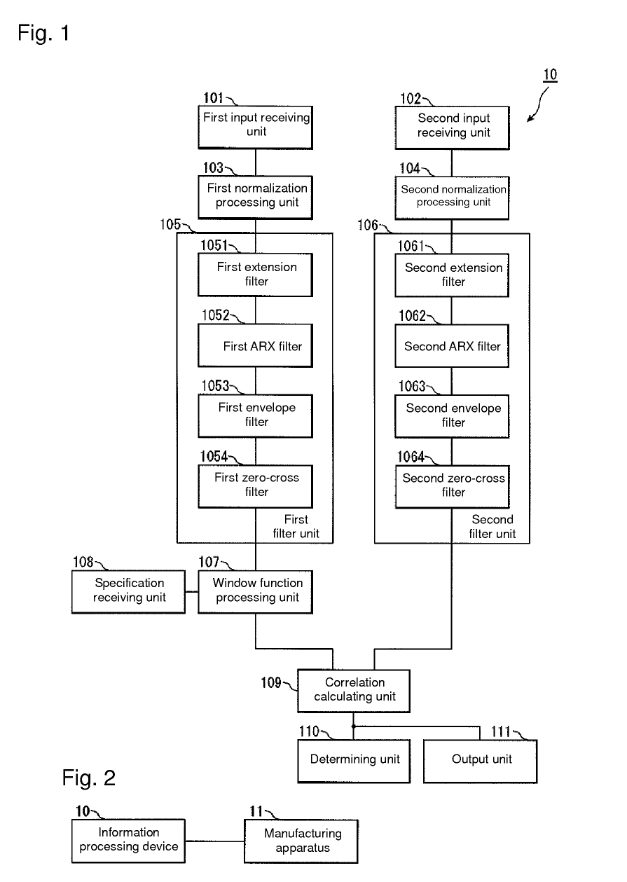

FIG. 1 is a block diagram of an information processing device according to the present embodiment.

FIG. 2 is a conceptual view of a semiconductor manufacturing apparatus management system equipped with the information processing device according to the present embodiment.

An information processing device 10 is directly or indirectly connected to a manufacturing apparatus 11 by way of a communication line and the like so as to be able to transmit and receive information. The information processing device 10 and the manufacturing apparatus 11 maybe connected by a network such as the Internet, a wireless or wired LAN and the like, or may be connected by a near field wireless communication such as Bluetooth (registered trademark), or may also be directly connected by a signal line.

The manufacturing apparatus 11 is a device for performing a intended semiconductor process on a processing substrate such as a semiconductor wafer and a liquid crystal panel substrate. The manufacturing apparatus 11 performs various types of processes on the processing substrate such as film forming process, etching process, and thermal oxidation process. The manufacturing apparatus 11 may a semiconductor manufacturing apparatus such as a semiconductor wafer manufacturing apparatus, a liquid crystal panel manufacturing apparatus, a plasma display panel manufacturing apparatus, and the like.

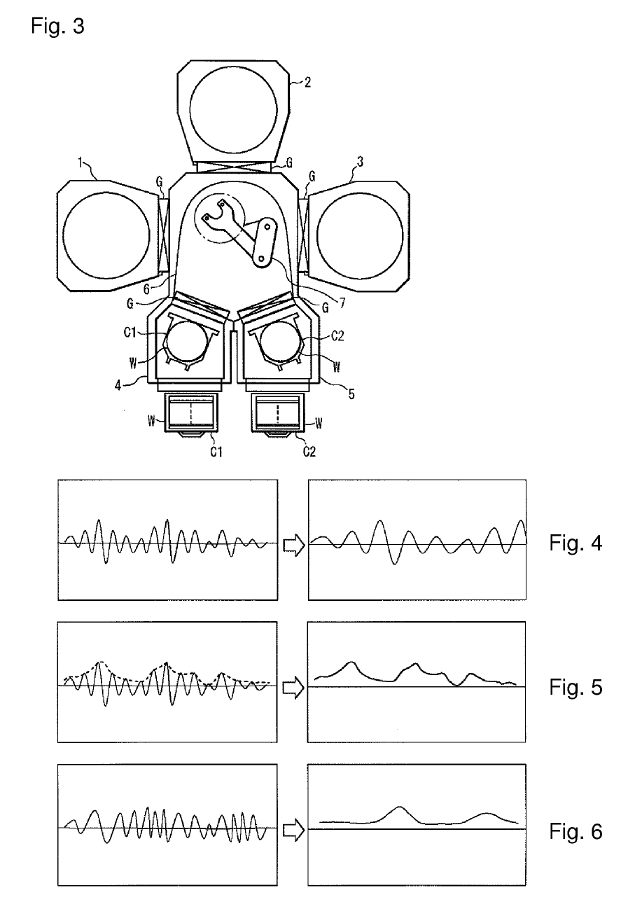

FIG. 3 is a view showing a semiconductor wafer manufacturing apparatus serving as an example of the manufacturing apparatus 11. The semiconductor wafer manufacturing apparatus of FIG. 3 is configured to include a plurality of, for example, three process chambers 1, 2, 3 for performing various types of processes such as film forming process, etching process, or thermal oxidation process on the semiconductor wafer; cassette chambers 4, 5 for accommodating cassettes C1, C2 that can accommodate a large number of, for example, fifty wafers W; and a transfer chamber 6 for exchanging the wafer W between the process chambers 1, 2, 3 and the cassette chambers 4, 5. Each chamber is coupled by way of a gate valve G in a freely opening and closing manner. A multiarticular transfer arm 7 capable of performing a bending operation and a rotating operation is arranged in the transfer chamber 6, where the wafer W is transferred between the chambers by the transfer arm 7. The cassettes C1, C2 are reversed 90 degrees when taken into the cassette chambers 4, 5 and rotated so that a wafer takeout/return port of the cassettes C1, C2 face the center of the transfer chamber 6, and are installed in an orientation where the wafer can be placed in/out by the transfer arm 7.

The manufacturing apparatus 11 stores a recipe information related to a intended process on the wafer, and performs the control of the manufacturing process using such recipe. The recipe is generally a set of process condition value and command on the device, information on the layout of the device, and the like.

The manufacturing apparatus 11 acquires one or more time-series data (hereinafter referred to as time-series data) related to the state of the own device, and outputs or transmits the same to the information processing device 10. Each time-series data described here is, for example, data configured by a multi-variable data corresponding to time, that is waveform data as a specific example. Specifically, the time-series data related to the state is data related to the operation state of the manufacturing apparatus acquired in time sequence by a sensor, a microphone, a measurement device, or the like, or data related to the operation state. The data related to the operation state includes data indicating what kind of process or control the manufacturing apparatus 11 has started or is executing, data indicating fluctuation of a control value of when controlling the manufacturing apparatus 11, or the like. The data related to the operation state of the manufacturing apparatus 11 includes actually measured measurement data during the operation of the manufacturing apparatus and the like such as temperature and pressure in the manufacturing apparatus 11, power amount supplied to the manufacturing apparatus, flow rate of the material gas, or the like during execution of one semiconductor process. The measurement data is acquired using one or more temperature sensors, one or more vibration sensors, one or more flow rate sensors, and the like. The manufacturing apparatus 11 generally adds the time data or information indicating time at which the time-series data is configured or time at which the measurement information is configuring the time-series data and the data indicating the operation state are acquired, and the like to the time-series data in correspondence to the measurement data and the data indicating the operation state, and outputs the same. Here, the time data corresponding to the time at which the information processing device 10 receiving the time-series data received the time-series data may be added in correspondence to the state data. Information indicating the type of measurement data such as “temperature” and “pressure” may also be added to the time-series data and outputted. Normally, one manufacturing apparatus 11 transmits a plurality of time-series data of different types. However, a plurality of manufacturing apparatuses 11 may transmit time-series data of one type. When a plurality of manufacturing apparatus 11 exists, the time-series data may be added with identification information for identifying each manufacturing apparatus 11 and transmitted so that the time-series data outputted from each manufacturing apparatus 11 can be identified.

The configuration in which the manufacturing apparatus 11 executes the process related to the intended semiconductor process on the processing substrate such as a wafer, the configuration in which the state data is acquired and transmitted, and the like are known techniques, and thus the detailed description thereof will not be given.

The information processing device 10 includes a first input receiving unit 101, a second input receiving unit 102, a first normalization processing unit 103, a second normalization processing unit 104, a first filter unit 105, a second filter unit 106, a window function processing unit 107, a designation receiving unit 108, a correlation calculating unit 109, a determining unit 110, and an output unit 111.

The first input filter unit 105 includes a first extension filter means 1051, a first ARX (autoregressive model with exogenous input) filter means 1052, a first envelope filter means 1053, and a first zero-cross filter means 1054.

The second input filter unit 106 includes a second extension filter means 1061, a second ARX filter means 1062, a second envelope filter means 1063, and a second zero-cross filter means 1064.

The first input receiving unit 101 receives first information or the time-series data related to the semiconductor process. The time-series data related to the semiconductor process may be any data as long as it is the time-series data related to the semiconductor process, and is, for example, time-series data indicating the state during processing (during execution) of the semiconductor process, specifically, waveform data and the like configured by a plurality of data outputted by the sensor, the microphone, and the like arranged in the interior or the exterior of the semiconductor related manufacturing apparatus such as the manufacturing apparatus 11 during execution of one process. For example, the first input receiving unit 101 may receive such data directly or indirectly from the manufacturing apparatus 11 and the like. The time-series data may be data obtained by processing the above data such as statistically processed data. The time-series data may be data created by simulation and the like in advance and assumed to be obtained during execution of the semiconductor process. Here, a case where the first information is information (hereinafter referred to as reference information) referenced when making some kind of determination on the second information, to be hereinafter described such as when making a determination on whether or not the second information is normal information will be particularly described. The reference information may be considered as data that becomes a reference of target for comparison. “Receive or receiving” referred herein includes receipt of information transmitted via the network and the like from the outside, input of information via the signal line and the like, readout of information from the recording medium and the like recorded with the first information, and the like. The first input receiving unit 101 is realized by a wired or wireless communication means, an input interface and a driver thereof for signal input, a device driver of a device for reading out information from a recording medium, and the like.

The second input receiving unit 102 receives the second information or the time-series data related to the semiconductor process. The second information is the time-series data related to the semiconductor process similar to the first information. The second input receiving unit 102 may directly or indirectly receive such data from the manufacturing apparatus 11, and the like. Here, a case where the second information is information (hereinafter referred to as target information) that becomes a target for detecting the state of the semiconductor process of the actually measured data measured during execution of the semiconductor process, and the like will be particularly described. The target information maybe considered as information to be examined. Particularly, when the first filter unit 105 described below is used, the first information and the second information may be information in which a propagating pathway, specifically, a path on which the information is transmitted, a measurement item, a measurement position, a measurement means, a measurement unit, and the like are the same or different. For example, the first information may be the information of the measurement value of the temperature sensor of the manufacturing apparatus 11, and the second information may be the waveform information of when the sound of the interior of the manufacturing apparatus 11 is collected with the microphone. The configuration of the second input receiving unit 102 is similar to the configuration of the first input receiving unit 101, and thus the description thereof will not be given herein.

The first normalization processing unit 103 performs a normalization process of normalizing the first information. The normalization process is a process of deforming the first information and the second information that do not have a constant shape having a desired property for the operation of comparison, calculation and the like, that is, deforming the first information and the second information without a normalized form to a normalized form. As a specific example, a process of performing an average value and variance value normalization of correcting the first information such that the average is 0 and the variance is 1 is given. The window function processing function 107, to be hereinafter described, takes out window acquiring information, to be hereinafter described, from the first information processed by the first normalization processing unit 103. The first information subjected to the normalization process in the first normalization processing unit 103 may be directly inputted as is to the window function processing unit 107, or may be indirectly inputted through other processing units and the like. The first normalization processing unit 103 is generally realized by an MPU, a memory, and the like. The processing procedure of the first normalization processing unit 103 is generally realized by software, where such software is recorded on the recording medium such as a ROM. It may also be realized by hardware (dedicated circuit). The first normalization processing unit 103 may be omitted if the first information does not need to be normalized.

The second normalization processing unit 104 performs a normalization process of normalizing the second information. The correlation calculating unit 109, to be hereinafter described, calculates the cross-correlation function of the window acquiring information, to be hereinafter described, and the second information processed by the second normalization processing unit 104. The cross-correlation function is a function used to represent similarity and the like of two signals. The second information subjected to the normalization process in the second normalization processing unit 104 may be directly inputted as is to the correlation calculating unit 109, or may be indirectly inputted through other processing units and the like. The configuration of the second normalization processing unit 104 is similar to the first normalization processing unit 103, and thus the description thereof will not be given. The second normalization processing unit 104 may be omitted if the second information does not need to be normalized.

The first filter unit 105 performs a filtering process on the first information. For example, the filtering process for absorbing signal change due to change in the propagating pathway with the second information is performed on the first information. The filtering process may be performed for other purposes. For example, the information may not have a constant form such as waveform having a desired property for processing such as comparison and calculation even if it is the information outputted from the same propagating pathway. In such a case, the filtering process and the like may be performed to obtain the information of a constant shape having the desired property for processing. The processes such as noise removal and removal of variations of the waveform are effective for the filtering process of such purpose. The window function processing unit 107, to be hereinafter described, retrieves the window acquiring information, to be hereinafter described, from the first information processed by the first filter unit 105. The first information processed by the first filter unit 105 maybe directly inputted to the window function processing unit 107 as is, or may be indirectly inputted through other processing units and the like. Here, a case of performing the filtering process on the first information processed by the first normalization processing unit 103 has been described by way of example, but the first information received by the first input receiving unit 101 may be directly subjected to the filtering process. Furthermore, this filter-processed first information may be subjected to the normalization process in the first normalization processing unit 103 and the like. In other words, the order of processing of the first normalization processing unit 103 and the first filter unit 105 may be arbitrary. The timing, the trigger and the like at which the first filter unit 105 performs the filtering process are arbitrary. What kind of filtering process to be performed on the first information may be determined in advance based on the characteristics of the information, the past experiment results and the like according to the relationship with the first information to be applied with the filtering process and the second information, or may be appropriately selected or switched and applied by the user. The parameters and the like in each filtering process may be set in advance according to the characteristics of the information, the past experiment results, the simulation result and the like.

The propagating pathway is a pathway showing how the information related to a certain factor in the manufacturing apparatus 11 or the manufacturing process is transmitted, and may be a pathway in which each of a plurality of information of the same measurement item measured for a certain factor is transmitted to the information processing device 10 or may be considered as transmission of information in which information related to a certain factor is measured in different forms. For example, it may be considered as transmission of information measured in different measurement items such as a sound and vibration with respect to a certain factor. The filtering process for absorbing change of a signal due to difference of the propagating pathway is a process for correcting and absorbing difference in signal of two information caused by the difference in the propagating pathways of the first information and the second information such as the difference in the delay and extension of time, frequency band for transmitting the signal, and the like due to the difference in the propagating pathways when the first information and the second information are information acquired on different propagating pathways. The filtering process for absorbing such a change in signal includes an extension filtering process, ARX filtering process, and the like. For example, the first filter unit 105 may execute at least one of the extension filtering process, ARX filtering process, envelope filtering process, or zero-cross filtering process for the filtering process for correcting the difference in waveforms due to the difference of the propagating pathways. The extension filtering process and the ARX filtering process, the envelope filtering process, and the zero-cross filtering process will be described below. Here, described is a case where the first filter unit 105 includes the first extension filter means 1051 for performing the extension filtering process, the first ARX filter means 1052 for performing the ARX filtering process, the first envelope filter means 1053 for performing the envelope filtering process, and the first zero-cross filter means 1054 for performing the zero-cross filtering process as means for performing the filtering process for absorbing the difference in waveforms due to the difference of the propagating pathways. The first filter unit 105 may include at least one or more of the first extension filter means 1051, the first ARX filter means 1052, the first envelope filter means 1053, and the first zero-cross filter means 1054. The first filter unit 105 may change the processing order of the first extension filter means 1051, the first ARX filter means 1052, the first envelope filter means 1053, and the first zero-cross filter means 1054, as necessary. The means that do not need to be applied on the first information of such means may not perform the process. The first filter unit 105 is generally realized by an MPU, a memory, and the like. The processing procedure of the first filter unit 105 is generally realized by software, and the software is recorded on a recording medium such as a ROM. However, it may be realized by hardware (dedicated circuit). The first filter unit 105 is particularly effective when the first information and the second information are information of different propagating pathways generated from the same factor, where the first filter unit 105 may be omitted when the filtering process for absorbing the difference of the propagating pathways is unnecessary with respect to the first information such as when the first information and the second information are information obtained with the same propagating pathways.

The first extension filter means 1051 performs the extension filtering process for absorbing change of signal due to the difference of the propagating pathway with the second information with respect to the first information. The extension filter is a nonlinear filter, and is a process for absorbing signal change for every propagating pathway by deforming the first information in the time axis direction when the signal extends by the propagating pathway. Specifically, as shown in FIG. 4, the first extension filter means 1051 creates a temporally extended signal by interpolating and extending the signal or decimating and contracting the signal. The configuration of the extension filter is a known technique, and thus the detailed description thereof will not be given.

The first ARX filter means 1052 performs the ARX filtering process for absorbing change of signal due to the difference of the propagating pathway with the second information with respect to the first information. The first ARX filter means 1052 is a process for absorbing the signal change for every propagating pathway by representing the difference of the propagating pathways of the first information and the second information with the ARX model and predicting the second information from the first information. The ARX filter is a linear filter, and the calculating formula of the ARX filter is expressed as below.

$$y ( t ) = {b}_{0} x ( t ) + {b}_{1} x ( t - 1 ) + … + {b}_{n} x ( t - n ) - {a}_{1} y ( t - 1 ) - {a}_{2} y ( t - 2 ) … - {a}_{m} y ( t - m )$$

(a₁, . . . , aₘ, b₀, . . . , bₙ are ARX model coefficients)

In the ARX filter, a process of calculating the ARX model coefficients from the first information, which becomes a sample, and the second information in advance, and estimating the second signal from the first information in actual use is performed. The configuration of the ARX filter is a known technique, and thus the detailed description thereof will not be given.

The first envelope filter means 1053 performs the envelope filtering process for absorbing change of the signal due to the change of the propagating pathway with the second information with respect to the first information. The envelope filter is a nonlinear filter, and absorbs the signal change for every propagating pathway by taking the correlation focusing on the strong and weak change of the entire signal when the frequency band for transmitting the signal is different. Specifically, as shown in FIG. 5, the first envelope filter means 1053 outputs a signal showing strong and weak of the signal in a pseudo manner by taking a movement average of the absolute value of the input signal. The configuration of the envelope filter is a known technique, and thus the detailed description thereof will not be given.

The first zero-cross filter means 1054 performs the zero-cross filtering process for absorbing change of the signal due to the difference of the propagating pathway with the second information with respect to the first information. The zero-cross filtering process is a nonlinear filter, and absorbs the signal change for every propagating pathway by taking the correlation focusing on the frequency change with respect to the signal in which the strong and weak of the signal barely changes. Specifically, as shown in FIG. 6, the first zero-cross filter means 1054 counts how many times the first signal crosses the zero value per unit time, and outputs a signal showing the frequency change of the signal in a pseudo manner. The configuration of the envelope filter is a known technique, and the detailed description thereof will not be given.

The second filter unit 106 performs the filtering process on the second information. For example, the filtering process for absorbing the signal change due to the propagating pathway with the first information is performed on the second information. However, similar to the first filter unit 105, the filtering process may be performed for other purposes. The configuration and the like of the second filter unit 106 are similar to the first filter unit 105 except that the information and the like to be processed are different, and thus the description thereof will not be given herein. By way of example, the second filter unit 106 includes the second extension filter means 1061, the second ARX filter means 1062, the second envelope filter means 1063, and the second zero-cross filter means 1064. The fact that the processing order and the like can be changed, or that the second filter unit 106 may not include all of such means are similar to the first filter unit 105. The type of the filtering process the parameter, and the like applied on the second information may be set in advance based on the past experiment result and the like or may be appropriately switched, similar to the first information.

The second extension filter means 1061 performs the extension filtering process for absorbing change of signal due to the difference of the propagating pathway with the first information with respect to the second information. The second extension filter means 1061 may be omitted if the first filter unit 105 includes the first extension filter means 1051. The configuration of the second extension filter means 1061 is similar to the configuration of the first extension filter means 1051, and thus the detailed description thereof will not be given.

The second ARX filter means 1062 performs the ARX filtering process for absorbing change of signal due to the difference of the propagating pathway with the first information with respect to the second information. The second ARX filter means 1062 may be omitted if the first filter unit 105 includes the first ARX filter means 1052. The configuration of the second ARX filter means 1062 is similar to the configuration of the first ARX filter means 1052, and thus the detailed description thereof will not be given.

The second envelope filter means 1063 performs the envelope filtering process for absorbing change of the signal due to the difference of the propagating pathway with the first information with respect to the second information. The envelope processing is generally performed in both the first filter unit 105 and the second filter unit 106. Therefore, if the first filter unit 105 includes the first envelope filter means 1053, the second envelope filter means 1063 is also arranged in the second filter unit 106. The configuration of the second envelope filter means 1063 is similar to the configuration of the first envelope filter means 1053, and thus the detailed description thereof will not be given.

The second zero-cross filter means 1064 performs the zero-cross filtering process for absorbing change of the signal due to the difference of the propagating pathway with the first information with respect to the second information. The zero-cross filtering process is generally performed in the first filter unit 105 and the second filter unit 106. Therefore, if the first filter unit 105 includes the first zero-cross filter means 1054, the second zero-cross filter means 1064 is also arranged in the second filter unit 106. The configuration of the second zero-cross filter means 1064 is similar to the configuration of the first zero-cross filter means 1054, and thus the detailed description thereof will not be given.

The window function processing unit 107 retrieves the information within a intended period of the first information using a window function. The information obtained by retrieving is the window acquiring information. The first information to be retrieved is the first information processed by the first filter unit 105. If the first filter unit 105 is omitted, the first information to be retrieved may be the first information normalized by the first normalization processing unit 103. If the first normalization processing unit 103 is also omitted, the retrieving target may be the first information received and outputted by the first input receiving unit 101. The window function is a function for clipping out the information within a specified period of the time-series data. When the window function is multiplied on a certain data, the value becomes zero other than in the period specified by the user and the like, and only the data of the specified period remains, whereby the data of the specified period can be retrieved. The specified period is preferably a period considered to be representing the desired characteristics of the first information. The desired characteristics are the characteristic indicating that the manufacturing apparatus 11 or the specific area thereof is abnormal, or the characteristic indicating that the manufacturing apparatus 11 or the specific area thereof is normal. The window function includes a function that retrieves the data of the specified period, and that retrieves the data by performing weighing according to the position within the period. A Hamming window and the like are specific examples of the window function. In this case, any window function may be used. The window function capable of reducing the weight of the data at both ends of the specified period and retrieving the data is preferably used. This is because both ends of the specified period on both sides often do not have high degree of importance. Since the window function is a known technique, the description thereof will not be given. The designation of the period for cutting out the information using the window function may be performed in any manner, may be specified in advance, or the designation may be received as necessary from the user and the like. A case of retrieving the first information within the specified period using the window function set in advance using the information for specifying the period received by the designation receiving unit 108, to be hereinafter described, will be described herein. The timing, the trigger and the like at which the window function processing unit 107 performs the process are arbitrary. The window function processing unit 107 is generally realized by an MPU, a memory, and the like. The processing procedure of the window function processing unit 107 is generally realized by software, and the software is recorded on a recording medium such as a ROM. It may also be realized by hardware (dedicated circuit).

The designation receiving unit 108 receives the designation of a intended period, which is a period of retrieving using the window function, of the first information. The designation of the period may be any designation such as designation of the starting point and the ending point, or the designation of the starting point and the length of the period. The designation of the period may be inputted with numerical value and the like, or may be inputted graphically by dragging the intended period of the first information using an input means such as a mouse. The input means used for the designation of the period may be any means such as a ten key, a keyboard, the mouse, and a menu screen. The designation receiving unit 108 is realized by the device driver of the input means such as the ten key and the keyboard, the control software of the menu screen, and the like.

The correlation calculating unit 109 calculates the cross-correlation function of the window acquiring information, which is the information retrieved by the window function processing unit 107, and the second information. The second information is the second information processed by the second filter unit 106. If the second filter unit 106 is omitted, the second information to be retrieved may be the second information normalized by the second normalization processing unit 104. If the second normalization processing unit 104 is also omitted, the retrieving target may be the second information outputted by the second input receiving unit 102. For example, the correlation calculating unit 109 calculates the correlation of each portion of the time-series information that can be represented with the waveform indicated by the second information and the time-series information outputted by the window information that can be represented with the waveform. The cross-correlation function is a function used to represent similarity and a time difference of two signal waveforms, and is a known technique, and thus the description thereof will not be given. The correlation calculating unit 109 is generally realized by an MPU, a memory, and the like. The processing procedures of the correlation calculating unit 109 are generally realized by software, and the software is recorded on the recording medium such as a ROM. It may also be realized by hardware (dedicated circuit).

The determining unit 110 determines whether or not information having high correlation with the window acquiring information is contained in the second information using the calculation result of the correlation calculating unit 109, and determines whether or not the second information is normal. For example, a threshold value and the like may be set in advance with respect to the cross-correlation function calculated by the correlation calculating unit 109, and when exceeding such a threshold value, determination may be made that the portion exceeding the threshold value or the second information is sufficiently correlated with the portion retrieved by the window function processing unit 107 of the first information, and the determination result specified in advance may be outputted for the relevant portion of the second information. The determination result specified in advance is specified in advance according to the first information retrieved by the window function. For example, if the portion retrieved using the window function by the window function processing unit 107 is the information of the period indicating the characteristics that abnormality occurred in the manufacturing process, the determination result indicating that the abnormality of the process and the like occurred within the relevant period if the cross-correlation function calculated by the correlation calculating unit 109 exceeds the threshold value. Alternatively, if the portion retrieved using the window function by the window function processing unit 107 is the information of the period indicating the characteristics that the manufacturing process is normal, the determination result indicating that the process is normally performed may be outputted if the cross-correlation function calculated by the correlation calculating unit 109 exceeds the threshold value. The determining unit 110 is generally realized by an MPU, a memory, and the like. The processing procedure of the determining unit 110 is generally realized by software, and the software is recorded on the recording medium such as a ROM. It may also be realized by hardware (dedicated circuit). In a case where determination is unnecessary, the determining unit 110 may be omitted.

The output unit 111 outputs the information corresponding to the calculation result of the correlation calculating unit 109. The information corresponding to the calculation result of the correlation calculating unit 109 is generally the determination result obtained by the determination made by the determining unit 110 on the calculation result of the correlation calculating unit 109. For example, the output unit 111 outputs the determination result of the determining unit 110 such as information indicating that abnormality occurred in the process. However, the information corresponding to the calculation result of the correlation calculating unit 109 may be the calculation result of the correlation calculating unit 109. For example, in a case where the determining unit 110 is omitted, in a case where the user desires to make the determination visually, or the like, the output unit 111 may display or print the cross-correlation function calculated by the correlation calculating unit 109 using a graph showing a waveform. The cross-correlation function may be outputted with the determination result. The output as referred to herein is a concept including display on the display, printing by the printer, sound output indicating occurrence of abnormality, accumulation in the recording medium, transmission to an external analyzer, and the like. The output unit 111 may be considered as including or as not including the output device such as the display and the speaker. The output unit 111 maybe realized by driver software of the output device, driver software of the output device and the output device, and the like.

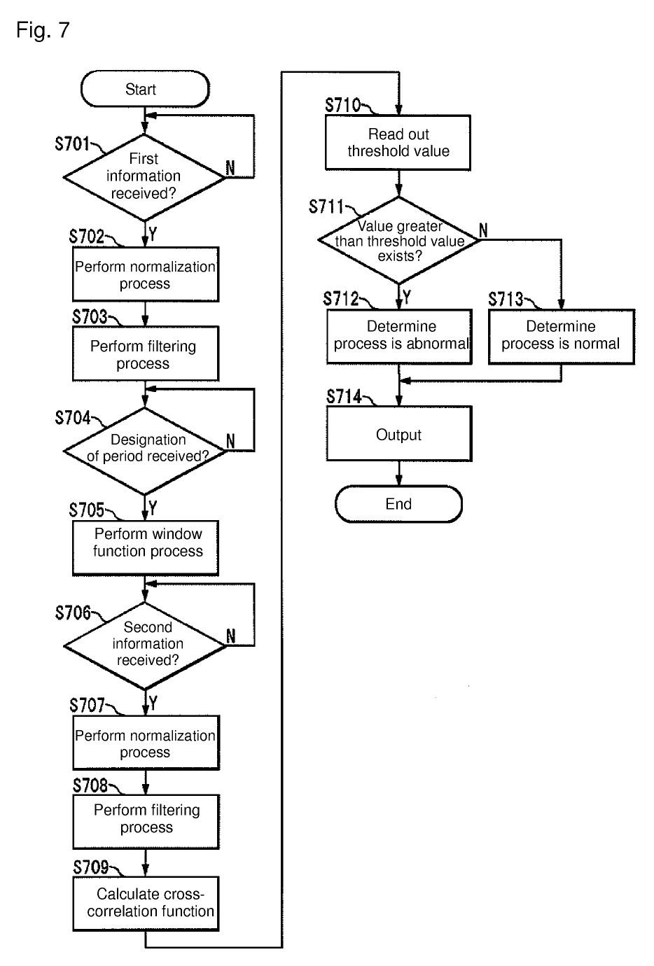

Next, the operation of the information processing device will be described using the flowchart of FIG. 7.

(Step S701) Whether or not the first input receiving unit 101 received an input is determined. The process proceeds to step S702 if received; the process returns to step S701 if not received.

(Step S702) The first normalization processing unit 103 performs the normalization process on the first information received in step S701. This step is omitted if the normalization process is unnecessary.

(Step S703) The first filter unit 105 performs the filtering process on the first information normalized in step S702. In the filtering process, a plurality of filtering processes may be performed in any order. This step is omitted if the filtering process is unnecessary.

(Step S704) The designation receiving unit 108 determines whether or not the designation of the period retrieved with the window function is received for the first information. The process proceeds to step S705 if received; the process returns to step S704 if not received.

(Step S705) The window function processing unit 107 applies the window function to the first information performed with the filtering process in step S703, and retrieves the first information of the period specified in step S704. The retrieved first information is temporarily stored in the memory, and the like.

(Step S706) Whether or not the second input receiving unit 102 received an input is determined. The process proceeds to step S707 if received; the process returns to step S706 if not received.

(Step S707) The second normalization processing unit 104 performs the normalization process on the second information received in step S706. This step is omitted if the normalization process is unnecessary.

(Step S708) The second filter unit 106 performs the filtering process on the second information normalized in step S707. In the filtering process, the plurality of filtering processes may be performed in any order. The second information performed with the filtering process is temporarily stored in the memory, and the like. This step is omitted if the filtering process is unnecessary.

(Step S709) The correlation calculating unit 109 calculates the cross-correlation function using the first information retrieved by the window function in step S705, and the second information subjected to the filtering process in step S708.

(Step S710) The determining unit 110 reads out the threshold value accumulated in the memory and the like (not shown). Here, a case will be described as an example where the window acquiring information acquired with the window function is the information indicating that the manufacturing process or the like is abnormal, and the maximum value of the range of values of the cross-correlation function that can determine whether the manufacturing process is normal is the threshold value.

(Step S711) The determining unit 110 determines whether or not a value greater than the threshold value exists in the calculated cross-correlation function. The process proceeds to step S712 when a large value exists; the process proceeds to step S713 when a large value does not exist. In some cases, the determining unit 110 may determine whether or not a value smaller than the threshold value exists in the calculated cross-correlation function. For example, in a case where the window acquiring information acquired with the window function is the information indicating that the manufacturing processor the like is normal, and the maximum value of the range of values of the cross-correlation function that can determine that the first information is abnormal is the threshold value, or the like, the determining unit 110 may determine whether or not a value smaller than the threshold value exists.

(Step S712) The determining unit 110 determines that abnormality occurred in the manufacturing process. The process then proceeds to step S714.

(Step S713) The determining unit 110 determines that the manufacturing process is normal. The process then proceeds to step S714.

(Step S714) The output unit 111 outputs the determination result of step S712 or step S713. It may also output the cross-correlation function calculated in step S709. In a case where the determination by the determining unit 110 is unnecessary, the processes from step S710 to step S713 may not be given. The process is then terminated.

The process terminates due to power OFF or interruption of process termination in the flowchart of FIG. 7.

Hereinafter, a specific operation of the information processing device according to the present embodiment will be described.

### Specific Example 1

The specific example describes a process of performing abnormality detection when the normalization process and the filtering process on the first information and the second information are omitted.

The conceptual view of the semiconductor manufacturing apparatus management system equipped with the information processing device according to the present embodiment is shown in FIG. 2.

To simplify the description, the time-series data measured for an intended item of the manufacturing apparatus 11 when abnormality occurred in the manufacturing process prepared in advance is the first information or the information of the referencing destination, and the measurement data to be analyzed that is measured during execution of the manufacturing process by the manufacturing apparatus 11 is the second information. Here, a case where the normalization process and the filtering process are omitted will be described. The first information and the second information shown in the specific example are prepared for the sake of convenience of explanation, and may not necessarily accurately indicate the actual measurement value.

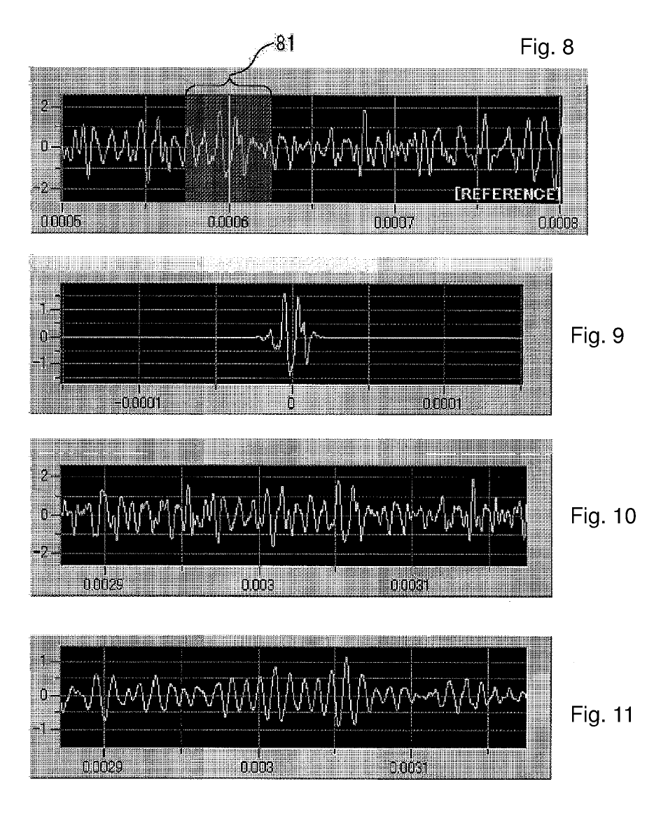

FIG. 8 is a view showing the first information in the waveform graph of time-series. In the figure, the horizontal axis indicates time and the vertical axis indicates measurement value. The first information is the information in which time and value are corresponded, that is, a set of (x, t) (x is value, t is time). Assume the first information as shown in FIG. 8 is stored in the memory and the like (not shown).

First, when the user gives an instruction to display the first information, the waveform graph of the first information as shown in FIG. 8 is displayed on the monitor screen and the like (not shown) of the information processing device 10. The user then operates the mouse and the like to select the portion to retrieve with the window function of the first information displayed on the monitor screen by dragging, and the like. A selected region 81 is displayed highlighted with a color different from other regions, as shown in FIG. 8. The portion to retrieve by the window function is the portion containing the characteristics of the first information. The characteristics as referred to herein are the characteristic wavelength portion that appears only when the manufacturing process is abnormal of the first information. Generally, in the measurement data such as the first information, the noise component becomes the dominant portion at the end, and thus the vicinity of the end is preferably not selected.

When the user gives an instruction to retrieve the selected region 81 with the window function to the information processing device, the designation receiving unit 108 receives the instruction to specify the period of the selected region 81 and the instruction to clip out the first information of the specified period with the window function. Here, the designation receiving unit 108 receives the instruction according to the instruction of the user, but the trigger and the like for the designation receiving unit 108 to receive the instruction may be arbitrary. For example, the instruction to clip out with the window function may be received at the point where the designation of the region by the user is terminated.

Since the normalization process and the filtering process are omitted, the window function processing unit 107 retrieves the window acquiring information, which is the information of the period specified by the designation receiving unit 108, of the first information using the window function according to such instructions.

FIG. 9 is a view showing the waveform of the information obtained by applying the window function to the first information in a graph. In the figure, the horizontal axis indicates time, and the vertical axis indicates value after application of the window function.

The characteristic portion of the first information can be retrieved by using the window function. A case of applying the window function of weighing such that the weight of the end of the specified region becomes small and clipping out the first information has been described for the window function. However, any window function may be used for the window function. The retrieved window acquiring information is then temporarily stored in the storage medium such as the memory (not shown).

Assume the second information, which is the measurement data to be analyzed, is received.

FIG. 10 is a view showing the second information in a waveform graph. In the figure, the horizontal axis indicates time, and the vertical axis indicates measurement value. The second information is the information in which time and value are corresponded, that is, a set of (x, t) (x is value, and t is time). For example, assume the manufacturing apparatus 11 sequentially transmits the second information or the measurement information to the information processing device 10, and the second input receiving unit 102 receives the second information. Since the normalization process and the filtering process by the second normalization processing unit 104 and the second filter unit 106 are omitted here, the received second information is temporarily stored in the memory and the like (not shown).

The correlation calculating unit 109 then reads out the window acquiring information and the second information from the memory, and calculates the cross-correlation function with the second information, which acts as the target of comparison, using the window acquiring information. The cross-correlation information to be calculated is the information indicating whether or not the characteristic same as the portion indicating the characteristic of the first information is contained in the second information, which acts as the target of comparison.

FIG. 11 is a view showing the cross-correlation function calculated by the correlation calculating unit 109 in a waveform graph. In the figure, the horizontal axis indicates time, and the vertical axis indicates value of correlation.

FIG. 11 shows that the area of time “0.00306” is the portion where the correlation of the window acquiring information and the second information is the highest.

The determining unit 110 then determines whether or not a value higher than a preset threshold value exists in the calculation result of the cross-correlation function shown in FIG. 11. For example, assuming “1” is stored in advance in the memory and the like as the threshold value for determining whether or not the manufacturing process is normally performed, the determining unit 110 detects a value exceeding “1”, or the threshold value, at the vicinity of the time “0.00306” in FIG. 11. In this manner, the determining unit 110 determines that abnormality occurred in the manufacturing process.

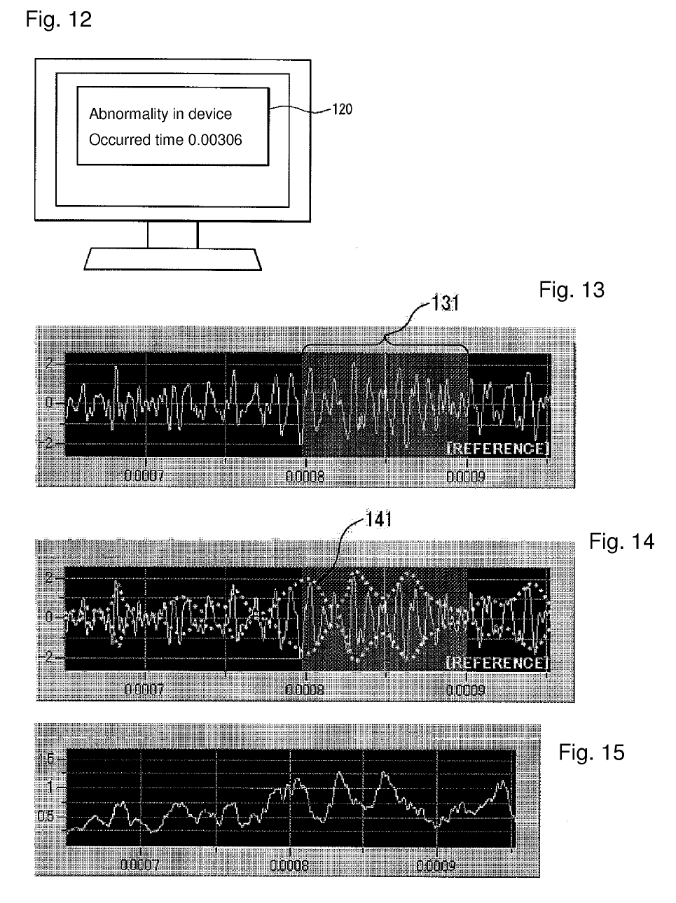

The output unit 111 displays the determination result by the determining unit 110 on the monitor screen and the like. FIG. 12 is a view showing the determination result by the determining unit 110 displayed on the monitor screen 120 by the output unit 111. As shown in FIG. 12, the determining unit 110 may detect the time at which the calculation result of the cross-correlation function exceeds the threshold value, and the output unit 111 may display the time and the like, or the detection result, on the monitor screen and the like. The output unit 111 may display the cross-correlation function as shown in FIG. 11 on the monitor screen and the like.

For example, the correlation calculating unit 109 and the like may detect the time of the time point at which the value of the cross-correlation function is the highest, and the output unit 111 may display this time of the time point at which the value of the cross-correlation relationship is the highest and the second information as shown in FIG. 10 on the display and the like. By referring to such display, the user can determine in a short period of time whether or not abnormality of the manufacturing process is occurring in the second information at the time point at which the value of the cross-correlation function is the highest.

In a specific example, the cross-correlation function between the window acquiring information retrieved from the first information using the window function and the second information is calculated, and the information corresponding to the calculation result is outputted. Thus, the correlation between the window acquiring information and the second information can be seen with the cross-correlation function, and the user can detect the state of the semiconductor process from the time-series data related to the semiconductor process at satisfactory accuracy.

In particular, in the present embodiment, the cross-correlation function between the window acquiring information retrieved from the first information using the window function and the second information is calculated. For example, if the cross-correlation function between the entire region of the first information and the entire region of the second information is calculated, the portion other than the portion indicating the characteristic of the manufacturing process and the like in the first information, or the reference information, and the unnecessary portion such as noise are also included in the calculation of the cross-correlation function, and thus an accurate comparison of waveforms may not be performed.

However, in the present embodiment, since the portion showing the characteristic of the first information and the like are retrieved with the window function, and the cross-correlation function between the retrieved portion and the second information is calculated, the correlation with the second information with respect to the unnecessary portion of the first information does not need to be obtained. As a result, the correlation of only the necessary portion can be accurately obtained, and the state of the semiconductor process can be accurately detected. Furthermore, by using the window function, the amount of data of the information referenced at the time of comparison can be reduced, the processing time at the time of comparison can be reduced, and the processing speed can be enhanced.

In the specific example described above, it should be recognized that the normalization process can be performed on the first information and the second information received by the first input receiving unit 101 and the second input receiving unit 102.

### Specific Example 2

Hereinafter, a second specific example of the present embodiment will be described.

In this specific example, the first information and the second information are information having different propagating pathways, and the information processing device 10 performs the filtering process on the first information and the second information with respect to the specific example described above.

FIG. 13 is a view showing the first information in a waveform graph of time-series. In the figure, the horizontal axis indicates time, and the vertical axis indicates measurement value. In this case, the first information as shown in FIG. 13 is stored in the memory and the like (not shown).

When the user gives an instruction to display the first information, the first information as shown in FIG. 13 is displayed on the monitor screen and the like (not shown) of the information processing device 10. The, user then operates the mouse and the like, and selects the portion to retrieve with the window function of the first information displayed on the monitor screen by dragging and the like. The selected region 131 is thus displayed highlighted with a color different from other regions, as shown in FIG. 13. The portion to retrieve with the window function is the portion including the characteristic of the first information. The characteristic as referred to herein is the characteristic wavelength portion, which appears only when the manufacturing process is abnormal, of the first information. Assume that the first information has a characteristic in which the vibrating signal intensity repeats strong and weak over in several times.

In the specific example, the first filter unit 105 applies on the first information the envelope filtering process for calculating, in a pseudo manner, an envelope line 141 representing the strong and weak of the signal in the first information as shown in FIG. 14 in order to capture the characteristic of the first information with respect to the first information. The first information obtained by such an envelope filtering process is shown in FIG. 15. In the figure, the horizontal axis indicates time, and the vertical axis indicates a value after application of the envelope filter. The filtering process may be performed with any trigger. For example, the filtering process may be performed in response to the instruction of the user, or the filtering process may be automatically performed at the time point the user specifies the region 131.

For example, when the user then gives an instruction to the information processing device to retrieve the selected region 131 with the window function, the designation receiving unit 108 receives the instruction to specify the period of the selected region 131 and the instruction to clip out the first information of the specified period with the window function.

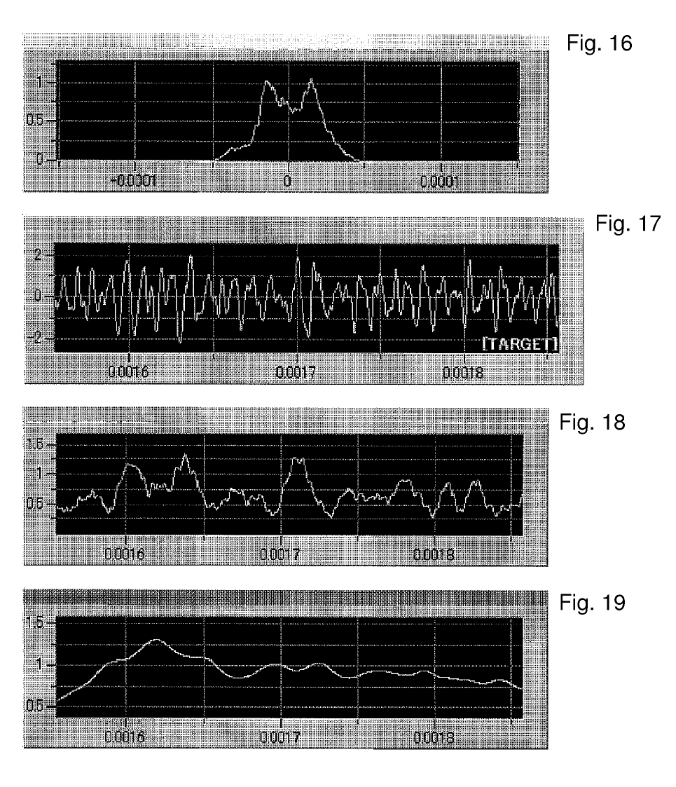

FIG. 16 is a view showing, in a form of graph, the waveform of the window acquiring information or the information obtained by applying the window function to the first information subjected to envelope filtering process. In the figure, the horizontal axis indicates time, and the vertical axis indicates value after application of the window function. The retrieved window acquiring information is temporarily stored in the storage medium such as the memory (not shown).

Assume the second information or the measurement data to be analyzed is then received.

FIG. 17 is a view showing the second information in a waveform graph. In the figure, the horizontal axis indicates time, and the vertical axis indicates measurement value.

The second filter unit 106 then applies the envelope filter similar to the first filter unit 105 on the second information.

FIG. 18 is a view showing the waveform graph of the second information applied with the envelope filter. In the figure, the horizontal axis indicates time, and the vertical axis indicates a value after application of the envelope filter. The second information is temporarily stored in the memory and the like.

The correlation calculating unit 109 then reads out the window acquiring information and the second information from the memory, and calculates the cross-correlation function with the second information, which acts as the target of comparison, using the window acquiring information.

FIG. 19 is a view showing the cross-correlation function calculated by the correlation calculating unit 109 in a waveform graph. In the figure, the horizontal axis indicates time, and the vertical axis indicates a value of correlation.

In FIG. 19, the area around time “0.00162” is the portion where the correlation of the window acquiring information and the second information is the highest, and it can be seen that the signal same as the characteristic desirably found in the first information is found at the relevant portion. In the information as shown in FIG. 18 obtained by simply applying the envelope filter to the second information, even if the portion where the value is the highest such as the portion of time “0.00172” does not change same as the pattern of the first information clipped out with the window function as shown in FIG. 16, the correlation value is low and it is not determined as the characteristic portion to be desirably found.

Thereafter, the determination according to the cross-correlation information, the output, and the like are performed, similar to the specific example described above, but the description thereof will not be given.

For example, even with the signals generated from the same factor, the waveform of the signal greatly differs in the time-series data of different propagating pathways, and the relevance may not be detected even if the cross-correlation function is calculated.

In such a case, an appropriate filtering process is performed on the time-series signal of different propagating pathway generated from the same factor to correct the difference in waveform caused by the difference in the propagating pathway, whereby the relevance can be correctly detected.

Moreover, in a case where the noise is large with respect to two time-series signals, the relevance can be correctly detected using the fact that the different noise factors are independent due to different propagating pathways.

In a case where a trouble occurs for some reason in the manufacturing process, the data associated with such a trouble may not be directly measured and observed. In such a case as well, the signal of the trouble may be transmitted as a signal of some kind of mechanical vibration or electrical fluctuation so as to be measured.

In such a case, the original signal may deform to different signals due to the difference between propagating pathways of the signal, or a typical noise of the propagating pathway may be superimposed on the signal. It is difficult to clearly sectionalize which interval is the phenomenon to be captured due to the deformation of the signal caused by the difference between propagating pathways. Thus, it is difficult to capture the phenomenon to be essentially captured by merely observing a single signal, and the correlation needs to be observed with the signals deformed differently. However, as shown in the present embodiment, the signal deformation due to difference between the propagating pathways is absorbed by the filtering process by performing linear or nonlinear filtering process on the first information and the second information, and the obscurity of the signal interval due to signal deformation can be absorbed by the window function, whereby the correlation of data of the first information and the second information can be obtained.

For example, in a module having a rotary mechanism such as a pump, the vibration data at normal time is set as the reference data, that is, the first information, and the time-series pattern at normal time having a signal characteristic quantity different from the vibration data is created by performing linear/nonlinear filter processing on the information. With this, the real time correlation with the data similarly processed with linear/nonlinear filter on the second information or the real time vibration measurement data of the manufacturing apparatus is calculated, so that normal/abnormal of the rotation system can be determined. In contrast, similar normal/abnormal determination can be performed with the vibration data at abnormal time as the first information or the reference.

In a manufacturing apparatus using electrical discharge, an electrical signal such as a current voltage of a discharge generator and an acoustic signal near the discharge generator are measured to detect the generation of abnormal discharge as a plurality of signals having different propagating pathways of the electrical signal and the acoustic signal. With respect to such signals, the difference in respective waveform is absorbed using the linear/nonlinear filter to correct the difference between waveforms of the electrical signal and the acoustic signal. Having one as the first information and the other as the second information, a short-time phenomenon is clipped out by the window function from the first information and the correlation function of the clipped-out window acquiring information and the second information is obtained so that a unique signal that appears in the two signals can be detected. In this manner, the state of the manufacturing process then can be determined with one signal as the reference information and using the other signal which is a different signal.

In the specific example described above, a case of performing the envelope filtering process has been described, but it should be recognized that other filtering process may be performed in the embodiment of the present invention. The normalization process may also be performed on the first information and the second information received by the first input receiving unit 101 and the second input receiving unit 102.

According to the present embodiment described above, the cross-correlation function between the window acquiring information retrieved from the first information using the window function and the second information is calculated, and the information corresponding to the calculation result is outputted, so that the correlation between the window acquiring information and the second information can be seen in the cross-correlation function, and the user can detect the state of the semiconductor process from the time-series data related to the semiconductor process at satisfactory accuracy.

In the present embodiment, in particular, the portion indicating the characteristic of the first information and the like are retrieved with the window function, and the cross-correlation function between the retrieved portion and the second information is calculated, and thus the correlation of only the necessary portion of the first information can be obtained, and the state of the semiconductor process can be accurately detected. Furthermore, through the use of the window function, the amount of data of the information referenced at the time of comparison can be reduced, the processing time at the time of comparison can be reduced, and the processing speed can be enhanced.

In the present embodiment, the filtering process is performed on the first information and the second information, so that the difference between propagating pathways and the like can be absorbed, and the state of the semiconductor process can be accurately detected from the time-series data of different propagating pathways.

### Second Embodiment

The present embodiment uses a set of first information and second information respectively outputted from a plurality of different propagating pathways of the manufacturing apparatus 11 to calculate the cross-correlation function, similar to the first embodiment, for every propagating pathway, and determines whether or not the portions determined to have high correlation of the cross-correlation function are relevant, to thereby detect abnormality and the like of the manufacturing apparatus 11 in the information processing device shown in the first embodiment.

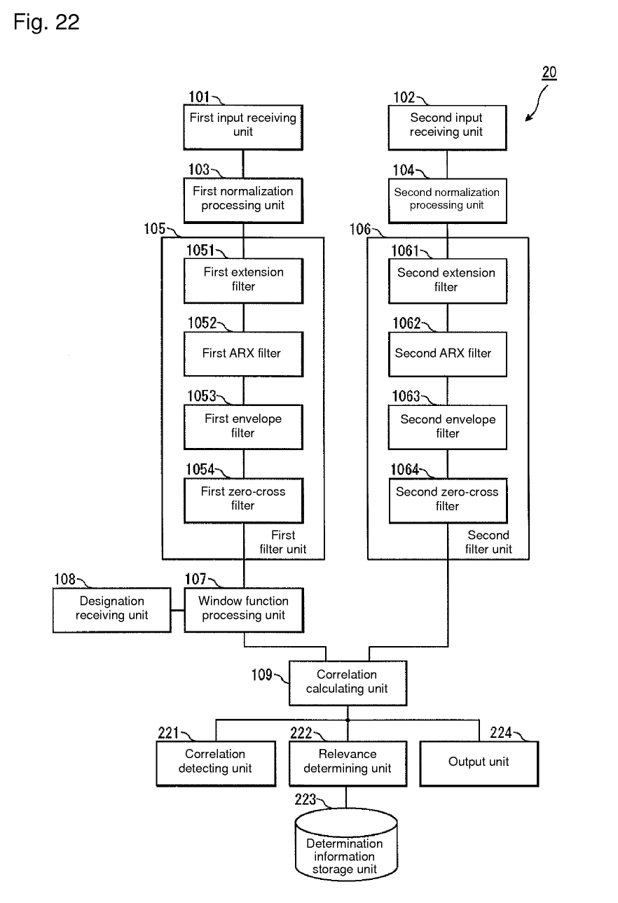

FIG. 22 is a block diagram showing a configuration of the information processing device of the present embodiment. Although not shown, the information processing device 20 of the present embodiment is directly or indirectly connected to the manufacturing apparatus 11 by way of a communication line or the like so as to be able to transmit and receive information, similar to the information processing device of the above-mentioned embodiment.

The information processing device 20 includes a first input receiving unit 101, a second input receiving unit 102, a first normalization processing unit 103, a second normalization processing unit 104, a first filter unit 105, a second filter unit 106, a window function processing unit 107, a designation receiving unit 108, a correlation calculating unit 109, a correlation detecting unit 221, a relevance determining unit 222, a determination information storage unit 223, and an output unit 224.

The configurations of the first input receiving unit 101, the second input receiving unit 102, the first normalization processing unit 103, the second normalization processing unit 104, the first filter unit 105, the second filter unit 106, the window function processing unit 107, the designation receiving unit 108, and the correlation calculating unit 109 are similar to the first embodiment, and thus the detailed description thereof will not be given.

The first input receiving unit 101 and the second input receiving unit 102 are assumed to receive a set of first information and second information respectively outputted for every plurality of different propagating pathways of the manufacturing apparatus 11 for a plurality of different propagating pathways. The first normalization processing unit 103, the second normalization processing unit 104, the first filter unit 105, and the second filter unit 106 perform the normalization process and the filtering process for every propagating pathway with respect to the first information and the second information received from the plurality of propagating pathways. The window function processing unit 107 acquires the window acquiring information, as described above, for each propagating pathway from the first information outputted from each propagating pathway received by the first input receiving unit 101. The designation receiving unit 108 receives the designation of an intended period for acquiring using the window function with respect to the first information outputted from each propagating pathway received by the first input receiving unit 101. In particular, the designation receiving unit 108 preferably receives the information specifying the period of the portion indicating the abnormality that occurred in the manufacturing apparatus 11 or the like such as the waveform portion indicating abnormality with respect to the first information outputted from each propagating pathway. The correlation calculating unit 109 calculates the cross-correlation function of the window acquiring information acquired from the window function processing unit 107 from the first information outputted from one propagating pathway, and the second information outputted from the same propagating pathway for each of the plurality of propagating pathways. The first information and the second information for every propagating pathway received by the first input receiving unit 101 and the second input receiving unit 102, the first information and the second information performed with the normalization process and the filtering process, the window acquiring information acquired for every propagating pathway, the information obtained by the above processing of the cross-correlation function calculated for every propagating pathway, and the like are appropriately stored in the storage medium such as the memory (not shown), so as to be read out. The process for receiving the first information and the second information, as described above, for every propagating pathway, the normalization process, the filtering process, the process for acquiring the window acquiring information, and the process for calculating the cross-correlation function may be carried out in time division. The first input receiving unit 101, the second input receiving unit 102, the first normalization processing unit 103, the second normalization processing unit 104, the first filter unit 105, the second filter unit 106, the window function processing unit 107, the designation receiving unit 108, the correlation calculating unit 109, and the like may be provided in plurals for every propagating pathway so as to perform the process in parallel.

If the normalization and filtering processes are unnecessary, the first normalization processing unit 103, the second normalization processing unit 104, the first filter unit 105, the second filter unit 106, and the like may be omitted. One or more filter means included in the first filter unit 105 and the second filter unit 106 may be appropriately omitted.

The correlation detecting unit 221 detects the portion of high correlation of the second information and the window acquiring information for each propagating pathway using the cross-correlation function calculated for each propagating pathway by the correlation calculating unit 109. How the correlation detecting unit 221 detects the portion of high correlation is arbitrary. For example, a threshold value and the like may be stored in a storage unit and the like (not shown) in advance for every propagating pathway with respect to the cross-correlation function calculated by the correlation calculating unit 109, and when exceeding the threshold value, the portion exceeding the threshold value of the cross-correlation function may be detected as the portion of high correlation of the window acquiring information acquired by the window function processing unit 107 of the first information and the second information. The correlation detecting unit 221 may binarize the cross-correlation function using the threshold value or the like, and detect the portion of high correlation by detecting the rising position or the like of the signal of the binarized data. Alternatively, only the portion of highest value may be detected within a intended period. The portion of high correlation may be considered as the portion having correlation. The correlation detecting unit 221 acquires the information specifying the portion detected as having high correlation. For example, the correlation detecting unit 221 acquires the information of a time specifying the portion of high correlation. The portion detected as having correlation described herein may be one point or may be a period or a region. The correlation detecting unit 221 may configure the information of the portion detected as having high correlation from the cross-correlation function such as the information retrieved only with the waveform for every propagating pathway, as necessary. The correlation detecting unit 221 is generally realized by an MPU, a memory, and the like. The processing procedure of the correlation detecting unit 221 is generally realized by software, and the software is recorded on a recording medium such as a ROM. It may also be realized by hardware (dedicated circuit).

The relevance determining unit 222 determines whether or not the portions of high correlation detected for each propagating pathway by the correlation detecting unit 221 are relevant. Being relevant as referred to herein, means that the portions of high correlation are signals derived from one cause, and determination on whether they are relevant or not may be considered as the determination on whether or not the portions of high correlation are signals derived from one cause.

When determined that the portions of high correlation detected for each propagating pathway are relevant, the relevance determining unit 222 may determine that abnormality occurred in the manufacturing apparatus 11 or the like, and when determined that the portions are not relevant, the relevance determining unit 222 may determine that the portion of high correlation contained in the second information outputted from each propagating pathway is merely a noise or the like and that determination, may not be made that abnormality occurred in the manufacturing apparatus 11 or the like. The relevance determining unit 222 may only determine whether the portions are relevant or not, or may determine that abnormality occurred in the manufacturing apparatus 11, the manufacturing process, or the like when determined as relevant.

The relevance determining unit 222 makes a determination on whether or not a relationship specified in advance is satisfied for the determination on whether the portions are relevant or not. The relationship specified in advance is the relationship satisfied between the portions of the second information outputted from a different propagating pathway when the portions are highly correlated with the window acquiring information and signals derived from the same cause. Specifically, when the signal generated from one cause in the manufacturing apparatus 11 or the like is outputted as a plurality of derived signals through the plurality of different propagating pathways, the relationship is that satisfied by the portions (e.g., waveforms) that arise from the one cause and are contained in the plurality of derived signals. In other words, the relevance determining unit 222 determines that the portion of high correlation of the second information acquired from each propagating pathway is the portion indicating the signal generated from one cause when the portions of high correlation acquired for each propagating pathway by the correlation detecting unit 221 satisfy the relationship specified in advance.

The determination on whether or not the relationship specified in advance is satisfied is performed in relation to the characteristic quantity, such as time or phase, of the portions of high correlation detected for each propagating pathway by the correlation detecting unit 221. The relationship specified in advance is the relationship of the occurred time, amount of change in phase difference, delay amount (time difference in occurred time), attenuation amount, waveform shape, or the like of the portions of high correlation detected for each propagating pathway. For example, the relevance determining unit 222 may determine whether or not the portions of high correlation detected for each propagating pathway by the correlation detecting unit 221 occurred within a time specified in advance, and may determine that the relationship specified in advance is satisfied if occurred within the time specified in advance. Whether or not the delay amount (time difference) of the portions of high correlation detected for each propagating pathway by the correlation detecting unit 221 is within a range specified in advance may be determined, and when the delay amount is within the range specified in advance, determination may be made that the relationship specified in advance is satisfied. For example, determination may be made that the relationship specified in advance is satisfied when a signal of high correlation with the window acquiring information is detected in the second information outputted from the second propagating pathway until a intended period specified in advance is elapsed after the signal of high correlation with the window acquiring information is detected in the second information outputted from the first propagating pathway. The occurred time and the like of the portion of high correlation can be acquired from the detection result of the correlation detecting unit 221. The relevance determining unit 222 may detect the phase of the portion of high correlation detected for each propagating pathway by the correlation detecting unit 221, determine whether or not the phase difference of the portions of high correlation detected for each propagating pathway by the correlation detecting unit 221 is within a range specified in advance, and determine that the relationship specified in advance is satisfied when the phase difference is within the range specified in advance.

Determining whether or not the relationship specified in advance is satisfied may be considered as determining whether or not the condition specified in advance is satisfied. The information defining the relationship (condition) specified in advance can be calculated using a transfer function of each propagating pathway, modeling and simulation of the propagating pathway, or the like. The information defining the relationship (condition) to be satisfied by the signal generated by the same cause may be acquired through experiment such as actually generating a test signal with respect to the manufacturing apparatus 11 and the like, and acquiring the signal from different propagating pathways. For example, in a case where a sample sound is generated in the manufacturing apparatus 11, such sound is detected with an acoustic emission sensor or the like each attached to a position so that the sound goes through a different propagating pathway. With the detection result, the information defining the relationship assumed to be satisfied by the output signals may be acquired in such a case where the signal caused by the same cause is outputted through different propagating pathways. The value obtained by the experience of the user or the like may be used as the information defining the relationship specified in advance. The information indicating a period that also takes into consideration the fluctuation of value due to occurrence of error and the like is preferable. The information defining the determination condition used to determine whether or not the relationship or the condition specified in advance is satisfied is referred to as determination information herein. Such determination information is, for example, stored in advance in the determination information storage unit 223, to be hereinafter described. Such relationship or the condition specified in advance may also be considered as an expectation value for determining the portion of high correlation of the second information outputted from different propagating pathways as the signal generated from the same cause. The determination information is preferably information indicating a period that also takes into consideration the fluctuation of value due to occurrence of error or the like. The determination information is preferably provided for every set of two or more propagating pathways to be determined. The determination information common to the plurality of sets of propagating pathways to be determined may also be prepared.

The relevance determining unit 222 is generally realized by an MPU, a memory, and the like. The processing procedure of the relevance determining unit 222 is generally realized by software, and the software is recorded on a recording medium such as a ROM. It may also be realized by hardware (dedicated circuit).

The determination information storage unit 223 stores determination information, as described above. The determination information is acquired by the transfer function, modeling of the propagating pathway, experiment, or the like, as described above. The determination information may be accumulated by the user or may be accumulated at the time of factory shipment and installation. The determination information is, for example, accumulated in correspondence to the combination of a plurality of propagating pathways. The determination information storage unit 223 can be realized by a non-volatile or a volatile storage medium, or the like.

The output unit 224 outputs information corresponding to the calculation result of the correlation calculating unit 109. Here, output corresponding to the determination result obtained by the determination made by the relevance determining unit 222 is made using the calculation result of the correlation calculating unit 109. The output unit 224 may output information indicating the determination result of the relevance determining unit 222. When the determination result of the relevance determining unit 222 is the information indicating that the portions of high correlation detected for each propagating pathway by the correlation detecting unit 221 satisfy the relationship specified in advance, information indicating occurrence of abnormality in the manufacturing apparatus 11 or the process may be outputted. Other configurations of the output unit 224 are similar to the output unit 111 described above, and thus the description thereof will not be given.

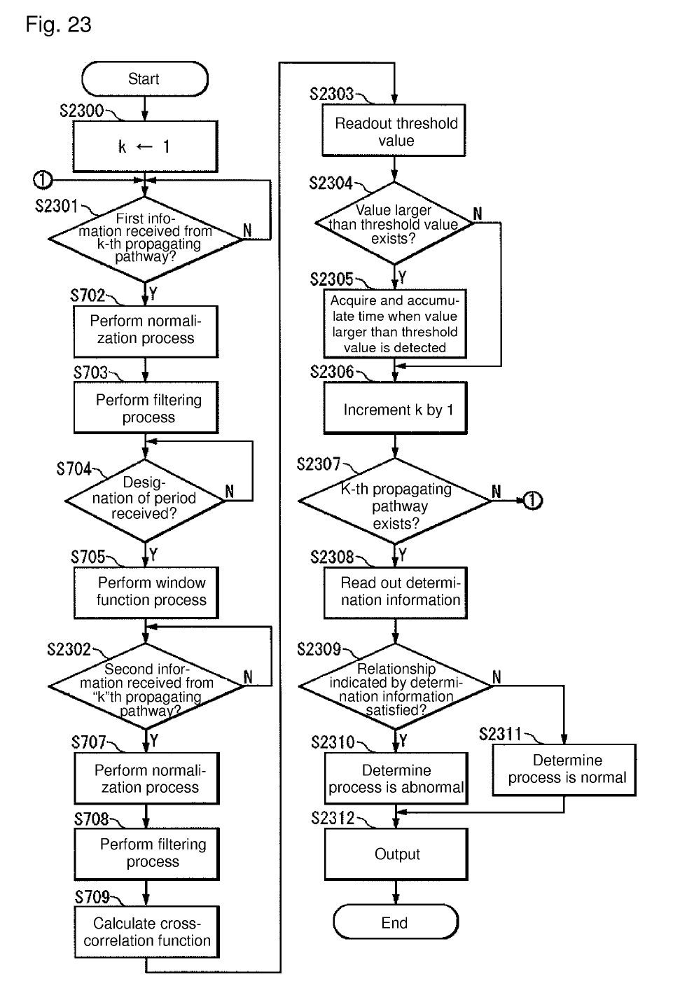

One example of the operation of the information processing device of the present embodiment will be described below with reference to a flowchart of FIG. 23. To simplify the description, described below is a case where the second information of the pre-specified period obtained from different propagating pathways is sequentially inputted to the second input receiving unit 102. In FIG. 23, the same reference numerals as in FIG. 7 are denoted for the same or corresponding steps.

(Step S2300) The information processing device 20 substitutes l to a counter k. The process then proceeds to step S2301.

(Step S2301) The first input receiving unit 101 determines whether or not the first information is received from the k-th propagating pathway. If received, the process proceeds to step S701. If not received, the process returns to step S2301.

(Step S2302) The second input receiving unit 102 determines whether or not the second information is received from the k-th propagating pathway. The process proceeds to step S707 if received, and the process returns to step S2302 if not received.

(Step S2303) The correlation detecting unit 221 reads out the threshold value accumulated in the storage unit (not shown).

(Step S2304) The correlation detecting unit 221 determines whether or not the cross-correlation function calculated in step S709 has a value larger than the threshold value exists for. The process proceeds to step S2305 if having a large value, and the process proceeds to step S2306 if having no large value.

(Step S2305) The correlation detecting unit 221 acquires information indicating time or information indicating the portion showing a value of the cross-correlation function larger than the threshold value. The acquired information of time is stored in the storage unit or the like (not shown). The time here is the information specifying the portion of high correlation with respect to the window acquiring information of the second information.

(Step S2306) The information processing device 20 increments the counter k by 1.

(Step S2307) The information processing device 20 determines whether or not the k-th propagating pathway exists. The process returns to step S2301 if it exists, and the process proceeds to step S2308 if it does not exist.

(Step S2308) The relevance determining unit 222 reads out the determination information stored in advance in the determination information storage unit 223.

(Step S2309) The relevance determining unit 222 determines whether or not the plurality of information of time acquired from a plurality of propagating pathways in step S2305 satisfy the relationship indicated by the determination information. For example, whether or not at least one time indicated by the information of time acquired from each of the plurality of propagating pathways instep S2305 is included per one propagating pathway may be determined within an occurrence period specified by the determination information acquired in step S2308. Alternatively, with respect to the time indicated by one information of time acquired from one propagating pathway specified by the determination information and the like, determination may be made on whether or not at least one time indicated by the information of time acquired from the remaining propagating pathways is included per propagating pathway within the period indicated by the delay time indicated by the determination information. The process proceeds to step S2310 if determined that the relationship is satisfied, and the process proceeds to step S2311 if determined that the relationship is not satisfied.

(Step S2310) The relevance determining unit 222 determines that abnormality occurred in the process.

(Step S2311) The relevance determining unit 222 determines that the process is normal.

(Step S2312) The output unit 224 outputs the determination result of the relevance determining unit 222. For example, the determination result is displayed on a monitor and the like. The process is then terminated.

In the flowchart, the process may be terminated at the time point the relationship is determined as not satisfied in step S2309.

In the flowchart, the successive second information outputted from different propagating pathways my be received by the second input receiving unit 102 in time division so that the process is repeatedly performed, or the successive second information outputted from different propagating pathways may be repeatedly subjected to parallel processing. The process of acquiring in advance the first information outputted from each propagating pathway to acquire the window acquiring information may be performed, and thereafter, the process of calculating the cross-correlation function may be performed on the second information outputted from each propagating pathway.

In the flowchart, if the determination information is the information specifying the period such as the occurrence period of abnormality, the processes of step S2303 and step S2304 may be executed after the process of step S2308 and the like, so that determination on whether or not a portion where the value is larger than the threshold value exists can be made only on the period indicated by the determination information of the cross-correlation function after acquiring the determination information, and the time information of the portion where the value is larger than the threshold value may be acquired.

The specific example of the present embodiment will now be described.

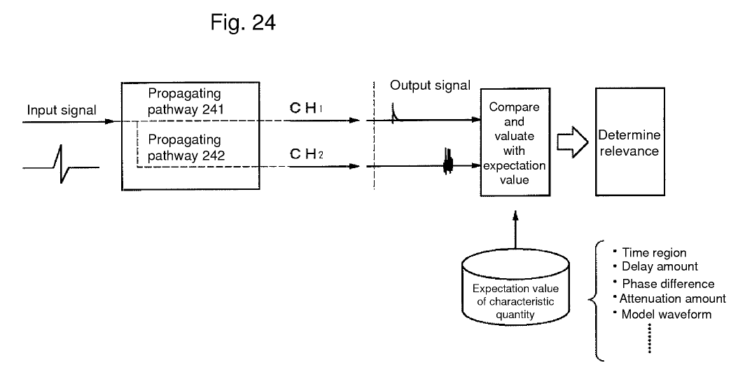

FIG. 24 is a view describing an outline of the configuration for detecting abnormality from the signals outputted from different propagating pathways by the information processing device according to the present embodiment. In the figure, the propagating pathway is modeled.

As shown in FIG. 24, when input signals caused by one cause are outputted from channel 1 (CH1) and channel 2 (CH2) through different propagating pathways 241 and 242, the signals outputted from each pathway generally becomes different signals according to the difference in pathway length of the propagating pathway, transfer function, or the like. However, the signals derived from one signal are usually relevant. Thus, the condition indicating the relevance between different signals outputted through different propagating pathways in correspondence to one input signal may be predicted using the transfer function of each propagating pathway or the model of the propagating pathway, or may be obtained through the experiment and the like. Therefore, the information indicating the conditions on the characteristic quantity of the signal such as time region, delay amount, phase difference, attenuation amount, model waveform, and the like for determining the relevance of a plurality of signals derived through different propagating pathways from one input signal, in other words, the expectation value is calculated using the transfer function of each propagating pathway or the model of the propagating pathway, or acquired through the experiment and the like and prepared in advance and stored in the determination information storage unit 223 and the like. If the portions indicating the occurrence of abnormality and the like acquired from each propagating pathway have the characteristic quantity satisfying the condition for determining the relevance specified in advance, such signals can be determined as being signals derived through a plurality of propagating pathways from one input signal. As a result, if the portions indicating the occurrence of abnormality and the like acquired from different propagating pathways 241 and 242 are relevant, determination can be made as being signals generated from one cause. If there is no or few relevance, determination is made as being signals that are not signals generated from one cause.

Hereinafter, a case of acquiring a signal wave each generated in the manufacturing apparatus 11 from two different propagating pathways (not shown) using the acoustic emission sensor (not shown) and inputting the signal acquired by the sensor to the first input receiving unit 101 and the second input receiving unit 102 as the, first information and the second information for each propagating pathway will be described by way of example. The two different propagating pathways will be referred to as a first propagating pathway and a second propagating pathway.

First, similar to the first embodiment, the cross-correlation function is calculated by receiving the first information and the second information outputted from the first and second propagating pathways, respectively, and using the information specifying the period to be retrieved using the window function of the first information inputted for every propagating pathway from the user. Byway of example, the area where abnormality occurred of the first information is retrieved using the window function, and the cross-correlation relationship with the retrieved window acquiring information is calculated.

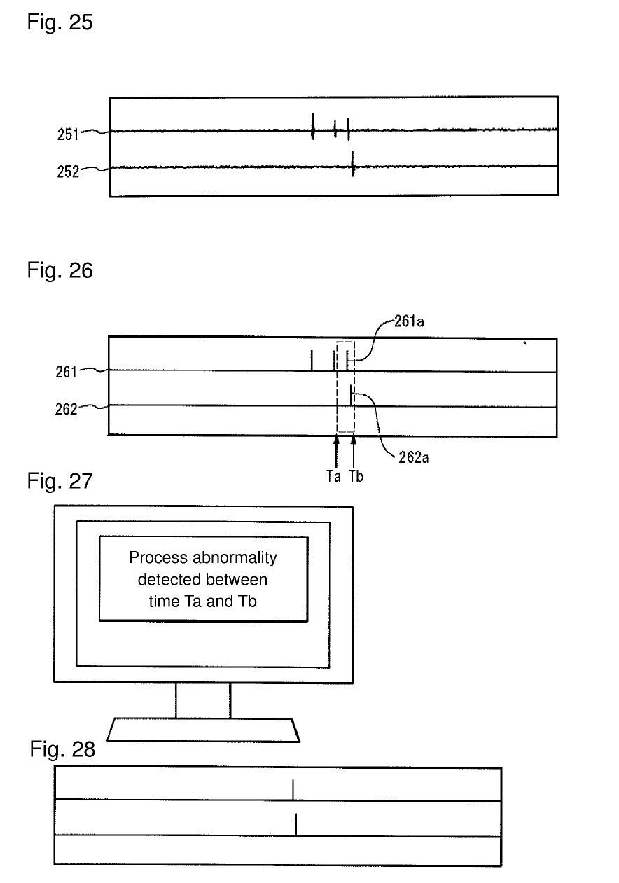

FIG. 25 is a view showing the cross-correlation function calculated using the first information and the second information respectively acquired from the first and second propagating pathways. The cross-correlation function 251 is a graph showing the cross-correlation function calculated using the first information and the second information acquired from the first propagating pathway, and the cross-correlation function 252 is a graph showing the cross-correlation function calculated using the first information and the second information acquired from the second propagating pathway. The horizontal axis indicates time and the vertical axis indicates a degree of correlation.

The correlation detecting unit 122 reads out the threshold value for determining the degree of correlation stored in advance in the storage medium and the like (not shown), and detects the portion of high correlation with the window acquiring information acquired from the first information for the cross-correlation function 251 and the cross-correlation function 252. For example, after acquiring each cross-correlation function, the cross-correlation function is first binarized using the threshold value, and the portion where the value is “H” is detected. The information of time of the portion where the detected value is “H” is then acquired. Such information of time is the information indicating the portion of high correlation of the cross-correlation function. The acquired information of time indicating the portion of high correlation is stored in the storage medium and the like (not shown) in correspondence to each propagating pathway. The information that the cross-correlation function is binarized is also stored in the storage medium (not shown).

The relevance determining unit 222 then reads out from the determination information storage unit 223 the determination information for determining whether or not the portion of high correlation of the cross-correlation function 251 and the portion of high correlation of the cross-correlation function 252 are relevant. The determination information that is readout is the information specifying the period where, when abnormality based on one cause obtained using the model of the propagating pathway occurs, the signal waveform indicating such abnormality is expected to appear in the second information outputted from the first and second propagating pathways. Here, it is the information specifying the starting time Ta and the ending time Tb of the period.

FIG. 26 is an example of a view showing the information 261 binarizing the cross-correlation function 251 and the information 262 binarizing the cross-correlation function 252 acquired and stored by the correlation detecting unit 221, and the period 263 where the signal waveform indicating abnormality is expected to be detected indicated by the determination information. The position where the signal is “H” of the binarized signals 261, 262, that is, the position where the peak of the signal exists is the portion determined as having high correlation in the cross-correlation function, and the time information indicating such a position is stored in the storage medium (not shown) as the information indicating the portion of high correlation.

The relevance determining unit 222 determines whether or not at least one time indicated by the information indicating the portion of high correlation acquired using the threshold value from the cross-correlation function 251 and the cross-correlation function 252 exists in the period from the starting time Ta to the ending time Tb indicated by the determination information. In other words, determination is made on whether or not at least one portion where the signal is “H” of the information 261 binarizing the cross-correlation function 251 and the information 262 binarizing the cross-correlation function 252 is included in the period 263 indicated by the determination information shown in FIG. 26. Here, as shown in FIG. 26, the portion 261a where the signal is “H” of the information 261 binarizing the cross-correlation function 251 and the portion 262a where the signal is “H” of the information 262 binarizing the cross-correlation function 262 are respectively contained in the period 263 indicated by the determination information, and thus determination is made that at least one time indicated by the information indicating the portion of high correlation exists in the period indicated by the determination information. The relationship indicated by the determination information for determining relevance is thus satisfied, and determination is made that the portion 261a where the signal is “H” of the information 261 binarizing the cross-correlation function 251 and the portion 262a where the signal is “H” of the information 262 binarizing the cross-correlation function 252 are relevant. Specifically, the portion 261a and the portion 262a are determined as signals indicating the abnormality occurred from the same cause. Thus, the relevance determining unit 222 determines that abnormality occurred in the manufacturing apparatus 11. Determination is not consequently made as occurrence of abnormality for the portion where the signal is “H” that is not contained in the period indicated by the determination information. This is because if abnormality occurred in the manufacturing apparatus 11, it is to be outputted as data having relevance from each propagating pathway, but if the relevance is not determined, the portion of high relevance in the cross-correlation function has a high possibility of being noise and the like generated in the propagating pathway and the like and not the signal caused by abnormality.

The output unit 223 then outputs the information indicating the determination result of the relevance determining unit 222. The information indicating the abnormality of the manufacturing apparatus is detected is displayed on the monitor and the like, as shown in FIG. 27, along with the information indicating the period indicated by the determination information.

As shown in FIG. 28, the output unit 223 displays the information in which only the information of the period indicated by the determination information is taken out from the information 261 binarizing the cross-correlation function 251 and the information 262 binarizing the cross-correlation function 252 shown in FIG. 26 on the monitor and the like.

If the occurrence of abnormality is not determined, the output unit 223 may output a notification that abnormality did not occur.

As described above, according to the present embodiment, the determination information indicating the relationship of the signals derived from the signal indicating abnormality that occurred from one cause outputted from different propagating pathways is prepared in advance, and determination is made on whether or not the relationship of the portions of high correlation with the window acquiring information of the information outputted from a plurality of different propagating pathways satisfies the relationship indicated by the determination information. The relevance of different signals of the propagating pathway can then be evaluated. For example, whether or not the characteristic portion of different signals of the propagating pathway such as the portion indicating abnormality is the signal derived from the same cause can be recognized. As a result, the characteristic portion of the signals having relevance can be detected from different signals of the propagating pathway, and the process abnormality of the manufacturing process and the like can be accurately determined.

### Third Embodiment

The present embodiment uses the first information and the second information outputted from the same or different propagating pathways of the manufacturing apparatus 11 to calculate the cross-correlation function, similar to the first embodiment, and determines whether or not the information indicating abnormality of third information outputted from another propagating pathway exists in a relevant period with respect to the portion determined as having high correlation of the cross-correlation function.

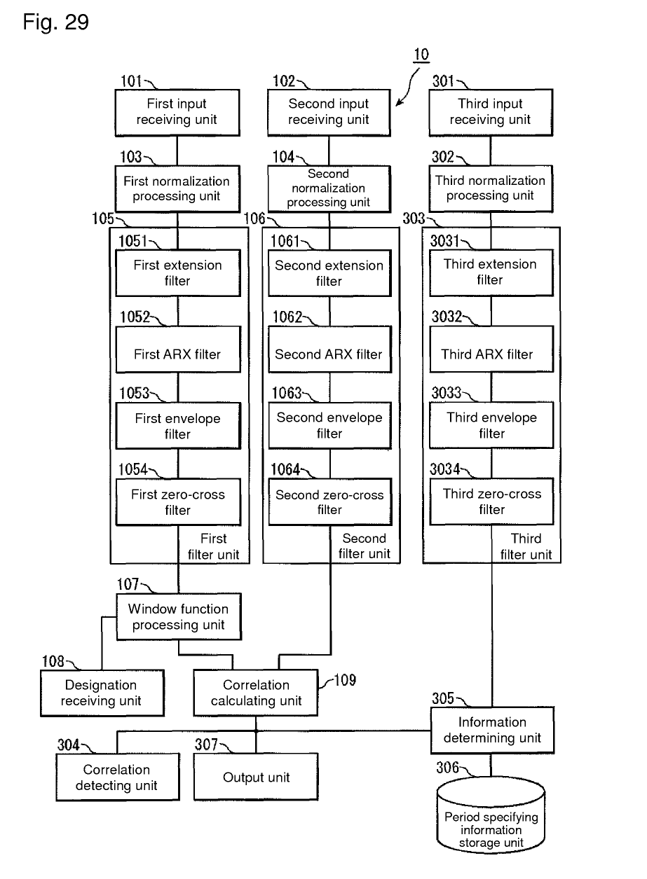

FIG. 29 is a block diagram showing a configuration of the information processing device of the present embodiment. Although not shown, the information processing device 30 of the present embodiment is directly or indirectly connected to the manufacturing apparatus 11 by way of a communication line and the like so as to be able to transmit and receive information, similar to the information processing device of the above-mentioned embodiment.

The information processing unit 30 includes a first input receiving unit 101, a second input receiving unit 102, a first normalization processing unit 103, a second normalization processing unit 104, a first filter unit 105, a second filter unit 106, a window function processing unit 107, a designation receiving unit 108, a correlation calculating unit 109, a third input receiving unit 301, a third normalization processing unit 302, a third filter unit 303, a correlation detecting unit 304, an information determining unit 305, a period specifying information storage unit 306, and an output unit 307.

The configurations of the first input receiving unit 101, the second input receiving unit 102, the first normalization processing unit 103, the second normalization processing unit 104, the first filter unit 105, the second filter unit 106, the window function processing unit 107, the designation receiving unit 108, and the correlation calculating unit 109 are similar to the first embodiment, and thus the detailed description thereof will not be given.

The first input receiving unit 101 and the second input receiving unit 102 receive the first information and the second information outputted from the same or different propagating pathways of the manufacturing apparatus 11 and the like. The window function processing unit 107 acquires the window acquiring information, as described above, from the first information outputted from one propagating pathway received by the first input receiving unit 101. The designation receiving unit 108 receives the designation of a intended period for acquiring using the window function with respect to the first information outputted from one propagating pathway received by the first input receiving unit 101. In particular, the designation receiving unit 108 preferably receives the information specifying the portion where abnormality occurred in the manufacturing apparatus 11 and the like such as the information specifying the period of the waveform portion indicating that abnormality occurred with respect to the first information outputted from one propagating pathway. The correlation calculating unit 109 calculates the cross-correlation function of the window acquiring information acquired by the window function processing unit 107 from the first information outputted from one propagating pathway, and the second information outputted from the same or different propagating pathways. The first information and the second information received by the first input receiving unit 101 and the second input receiving unit 102, the first information and the second information subjected to the normalization process and the filtering process, the acquired window acquiring information, the information obtained through the above processes such as the calculated cross-correlation function, and the like are appropriately stored in the storage medium such as the memory (not shown) and read out. In the embodiment described below, a case where the first input receiving unit 101 and the second input receiving unit 102 mainly receive the first information and the second information outputted from the same propagating pathway of the manufacturing apparatus 11 and the like will be described. The first input receiving unit 101 and the second input receiving unit 102 may receive the first information and the second information outputted from different propagating pathways of the manufacturing apparatus 11 and the like.

If the normalization process is unnecessary, the first normalization processing unit 103, the second normalization processing unit 104, the first filter unit 105, the second filter unit 106, and the like may be omitted. A case where the normalization process and the filtering process are unnecessary is, for example, a case where the first information and the second information are information generated by the same cause and outputted from the same propagating pathway, and have a constant form with the desired characteristic for operations such as comparison and calculation.

The third input receiving unit 301 receives one or more third information or time-series data outputted from one or more propagating pathways different from the propagating pathway through which the first information and the second information are outputted. The third information received by the third input receiving unit 301 is similar to the second information received by the second input receiving unit 102 except that the propagating pathway is different. The third input receiving unit 301 has a configuration similar to the second input receiving unit 302 and the like except that the received information is the third information outputted from a propagating pathway different from the propagating pathway through which the first information and the second information are outputted, or that one or more third information are received, and thus the description thereof will not be given. The third input receiving unit 301 may receive plural third information in time division, or the second input receiving unit 301 may be arranged in plurals in parallel to receive the information by parallel processing.

The third normalization processing unit 302 and the third filter unit 303 have configurations similar to the second normalization processing unit 104 and the second filter unit 106 of the embodiments described above except that the normalization process and the filtering process are performed on the one or more third information received by the third input receiving unit 301, and thus the description thereof will not be given.

A third extension filter means 3031, a third ARX filter means 3032, a third envelope filter means 3033, and a third zero-cross filter means 3034 of the third filter unit 303 also have configurations similar to the second extension filter means 1061, the second ARX filter means 1062, the second envelope filter means 1063, and the second zero-cross filter means 1064 described above except that the filtering process is performed on the third information outputted by the third normalization processing unit 302, and thus the description thereof will not be given.

The third normalization processing unit 302, the third filter unit 303, and the like may be omitted if the normalization process and the filtering process are unnecessary on the third information. One or more filter means contained in the third filter unit 303 may be appropriately omitted.

The correlation detecting unit 305 detects the portion of high correlation in the cross-correlation function calculated using the first information and the second information outputted from the propagating pathway, and is similar to the correlation detecting unit 221 of the above-described embodiment, and thus the description thereof will not be given.

The information determining unit 305 determines whether or not information indicating abnormality is detected within a period of the third information related to the portion of high correlation detected by the correlation detecting unit 304. The period relevant to the portion of high correlation detected by the correlation detecting unit 304 maybe considered as the period in pre-specified time relationship with respect to the portion of high correlation with respect to the window acquiring information of the second information. The relevant period as referred to herein is the period in which the signal derived from the same cause as the signal of high correlation of the second information detected by the correlation detecting unit 304 is predicted to be obtained in the third information. If the signal indicating abnormality based on the same cause is outputted through different propagating pathways, the portion indicating that abnormality of the second information occurred and the area where the abnormality of the third information occurred are assumed to have a intended time relationship. Therefore, if the portion of high correlation of the second information acquired from one propagating pathway is the portion indicating abnormality that occurred in the manufacturing apparatus 11 and the like, a signal indicating the abnormality occurred is assumed to be contained in the period having a intended time relationship with respect to the portion of high correlation of the second information for the third information obtained from a propagating pathway different from the one propagating pathway. Thus, the information determining unit 305 determines whether or not information indicating abnormality is detected in the relevant period with respect to the portion of high correlation detected by the correlation detecting unit 304. The relevant period is the period similar to the period containing the signals derived through different propagating pathways from one cause used in determining the relevance of the portions of high correlation with respect to the window acquiring information acquired from the second information of different propagating pathways in the second embodiment.

The information determining unit 305 may determine the relevant period in any manner. For example, information such as time difference, elapsed time and relative time for specifying the relevant third information period with respect to the time indicating the portion of high correlation detected by the correlation detecting unit 304 may be prepared in advance, and using such information, the relevant period with respect to the time indicating the portion of high correlation detected by the correlation detecting unit 304 may be acquired. The information specifying the relevant period may be considered as the information similar to the information specifying the delay amount and the like of the portions of high correlation of the determination information. The information specifying the period is referred to as period specifying information. The period specifying information is specified in advance by the user and the like. The period specifying information is preferably information indicating the period that also takes into consideration fluctuation of value due to occurrence of error and the like. The period specifying information may be prepared for every propagating pathway, or may be commonly prepared for a plurality of propagating pathways. If the period specifying information is prepared for every propagating pathway, the period specifying information corresponding to the propagating pathway to be determined is read out and used in determining the relevance for every propagating pathway. The period specifying information is stored in advance in the period specifying information storage unit 306, to be hereinafter described. The period specifying information specifying the relevant period can be acquired by modeling the propagating pathway or using the transfer function and the like, similar to the embodiment described above. The period specifying information may be experimentally acquired by actually measuring the delay time and the like on a trial basis actually using the test signal and the like.

The information determining unit 305 acquires the relevant period using the information indicating the time of portion of high correlation and the period specifying information with respect to the portion of high correlation detected by the correlation detecting unit 304. The information determining unit 305 determines whether or not the information indicating abnormality is contained within the relevant period of the third information. The information determining unit 305 may detect the information indicating abnormality from the third information in any manner. The information determining unit 305 performs detection of edge with respect to the third information, and determines the portion where the rise of edge is detected as the information indicating abnormality when the rise of the edge is detected. The process of performing edge detection from the waveform information is a known technique, and thus the description thereof will not be given. When a signal greater than a threshold value specified in advance to the third information is detected, the information determining unit 305 determines the detected portion as a signal indicating abnormality. If determined that the information indicating abnormality is contained, the information determining unit 305 may determine that abnormality occurred. The information determining unit 305 is generally realized by an MPU, a memory, and the like. The processing procedures of the information determining unit 305 are generally realized by software, and the software is recorded on a recording medium such as a ROM. It may also be realized by hardware (dedicated circuit).

The period specifying information used when the information determining unit 305 specifies the relevant third information period with respect to the portion of high correlation detected by the correlation detecting unit 304 may be stored in the period information storage unit 306. The period specifying information may be prepared for every propagating pathway for outputting the third information, or the period specifying information common to a plurality of propagating pathways may be prepared. The period specifying information is information prepared in advance by the user and the like. The period information storage unit 306 can be realized by a volatile or a non-volatile storage medium, and the like.

The output unit 307 outputs the information corresponding to the calculation result of the correlation calculating unit 109. In particular, output corresponding to the determination result obtained by the determination made by the information determining unit 305 is performed using the calculation result of the correlation calculating unit 109. The output unit 307 may output the information indicating the determination result of the information determining unit 307. If the determination result of the information determining unit 307 is the determination result indicating that the information indicating abnormality is detected within the relevant third information period with respect to the portion of high correlation detected by the correlation detecting unit 304, information indicating that the abnormality occurred in the manufacturing apparatus 11 and the process may be outputted. Other configurations of the output unit 307 are similar to the output unit 111, and thus the description thereof will not be given herein.

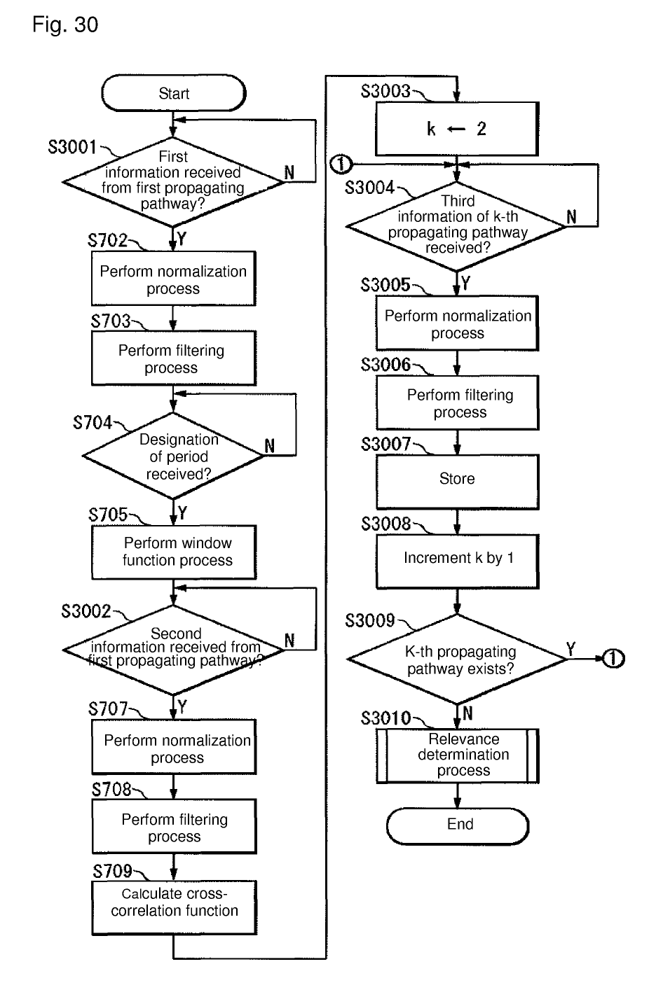

The operation of the information processing device of the present embodiment will be described with reference to the flowchart of FIG. 30. In FIG. 30, the same reference numerals as in FIG. 7 are denoted for the same or corresponding steps, and the description thereof will not be given herein.

(Step S3001) The first input receiving unit 101 determines whether or not the first information is received from the first propagating pathway. For the sake of convenience, the propagating pathway for outputting the first information and the second information is referred to as the first propagating pathway. The process proceeds to step S702 if received, and the process returns to step S3001 if not received.

(Step S3002) The second input receiving unit 102 determines whether or not the second information is received from the first propagating pathway. The second input receiving unit 102 may receive the second information from a propagating pathway different from the first propagating pathway. The process proceeds to step S707 if received, and the process returns to step S3002 if not received.

(Step S3003) The information processing device 30 substitutes 2 to a counter k.

(Step S3004) The third input receiving unit 301 determines whether or not the third information is received from a k-th propagating pathway. The process proceeds to step S3005 if received, and the process returns to step S3004 if not received.

(Step S3005) The third normalization processing unit 302 performs the normalization process on the third information received in step S3004.

(Step S3006) The third filter unit 303 performs the filtering process on the third information subjected to the normalization process in step S3005.

(Step S3007) The information processing device 30 stores the third information processed in step S3006 in the storage medium or the like (not shown).

(Step S3008) The information processing device 30 increments the value of the counter k by 1.

(Step S3009) The information processing device 30 determines whether or not the k-th propagating pathway exists. This determination can be considered as a determination on whether or not to receive the input of the third information from the k-th propagating pathway. The process returns to step S3004 if the k-th propagating pathway exists, and the process proceeds to step S3010 if it does not exist.

(Step S3010) The information processing device 30 performs a process of determining the relevance of the portion of high correlation, acquired in step S709 by the cross-correlation function, and the third information. The details of such process will be described below. The process is then terminated.

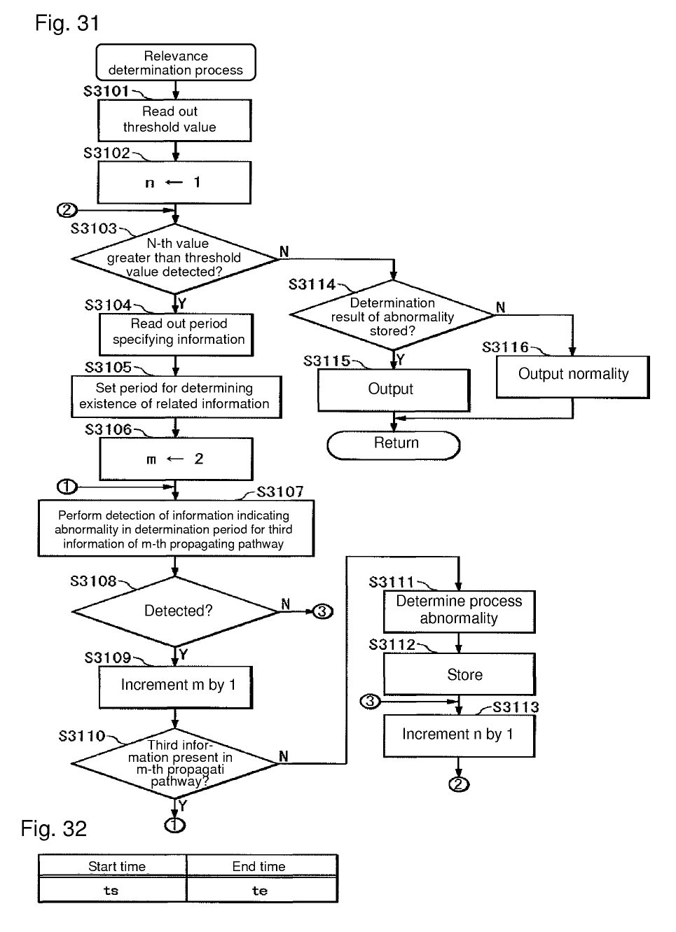

The details of the process for determining the relevance shown in step S3010 of FIG. 30 will be described with reference to the flowchart of FIG. 31.

(Step S3101) The correlation detecting unit 304 reads out the threshold value for determining the portion of high correlation of the cross-correlation function from the storage unit or the like (not shown).

(Step S3102) The correlation detecting unit 304 substitutes 1 to a counter n.

(Step S3103) The correlation detecting unit 304 determines whether or not the cross-correlation function calculated in step S709 of FIG. 30 has the portion including an n-th value larger than the threshold value, using the threshold value read out in step S3101. The detection of the value is preferably performed from the side of earlier time of the cross-correlation function. If having such a portion, the information of time indicating the portion of higher value than the threshold value is acquired, and the process proceeds to step S3104, and if having no such portion, the process proceeds to step S3114.

(Step S3104) The information determining unit 305 reads out the period specifying information stored in the period specifying information storage unit 305.

(Step S3105) The information determining unit 305 sets the period for determining whether or not the related information exists using the information of time of the n-th portion which value is larger than the threshold value detected in step S3103 and the period specifying information read out in step S3104. For example, if the detection start time of the n-th portion which value is larger than the threshold value detected in step S3103 is Tf and the information indicated by the period specifying information is the relative start time Ts and the end time Te having the detection start time as the reference of the period for determining relevance, the period for determining relevance is set from Tf+Ts to Tf+Te.

(Step S3106) The information determining unit 305 substitutes 2 to a counter m.

(Step S3107) The information determining unit 305 reads out the third information received from the m-th propagating pathway, and performs detection of the information indicating the occurrence of abnormality with the period set in step S3105 as the target range of detection with respect to the third information. For example, the edge detection of a signal determined as abnormal is performed within the period set in step S3105.

(Step S3108) The information determining unit 305 determines whether or not the information indicating occurrence of abnormality is detected in the detection process of step S3107. The process proceeds to step S3109 if detected, and the process proceeds to step S3113 if not detected.

(Step S3109) The information determining unit 305 increments the counter m by 1.

(Step S3110) The information determining unit 305 determines whether or not the third information acquired from the mth propagating pathway exists. The process returns to step S3107 if it exists, and the process proceeds to step S3111 if it does not exist.

(Step S3111) The information determining unit 305 determines the n-th portion of high correlation indicated by the cross-correlation determined in step S3103 as the portion indicating process abnormality.

(Step S3112) The information determining unit 305 stores the determination result of process abnormality in the storage unit such as the storage medium (not shown). The stored determination result preferably contains information that can indicate the n-th portion of high correlation determined as abnormal such as information of time, but may merely be information indicating that abnormality occurred.

(Step S3113) The correlation detecting unit 304 increments the value of the counter n by 1. The process then returns to step S3103.

(Step S3114) The information determining unit 305 determines whether or not the determination result of process abnormality in step S3112 is stored. The process proceeds to step S3115 if stored, and the process proceeds to step S3116 if not stored.

(Step S3115) The output unit 307 performs an output indicating that process is abnormal. The process then returns to the process of higher level.

(Step S3116) The output unit 307 performs an output indicating that process is normal. The process then returns to the process of higher level.

In the flowchart, the processes may be repeatedly performed so that the successive second information outputted from the first propagating pathway and the successive third information outputted from one or more propagating pathways are received in time division, or the successive second information outputted from different propagating pathways maybe repeatedly processed in parallel.

If the information indicating the determination result of process abnormality is not stored in step S3114, the process may return to the process of higher level.

The case of using the period specifying information common to the propagating pathway has been described, but if different period specifying information is prepared for every propagating pathway, the processes of step S3104 and step S3105 may be performed between the processes of step S3106 and step S3107, and the period specifying information corresponding to the m-th propagating pathway may be read out in step S3104.

If the processes of step S3112 and steps S3119 to S3116 are omitted, and the process abnormality is determined in step S3111, the determination result may be outputted and the process may proceed to step S3113.

Specific examples of the present embodiment will be described below.

In the present embodiment as well, the period specifying information created in advance by modeling the propagating pathway as shown in FIG. 24 is assumed to be stored in the period specifying information storage unit 306.

FIG. 32 is an example of the period specifying information stored in the period specifying information storage unit 306. The period specifying information is the information specifying the “start time” and the “end time” of the period of performing the determination of relevance when the portion of high correlation in the cross-correlation function is 0 second. Here, ts and te are values indicating time, where te>ts. Here, ts and te are negative values.

By way of example, the signal wave generated in the manufacturing apparatus 11 is acquired from the first to fourth propagating pathways (not shown) using the acoustic emission sensor (not shown). A case of acquiring the first information and the second information from the first propagating pathway, and acquiring the third information from the second to the fourth propagating pathways will be described. The second information may be acquired from the propagating pathway other than the first propagating pathway.

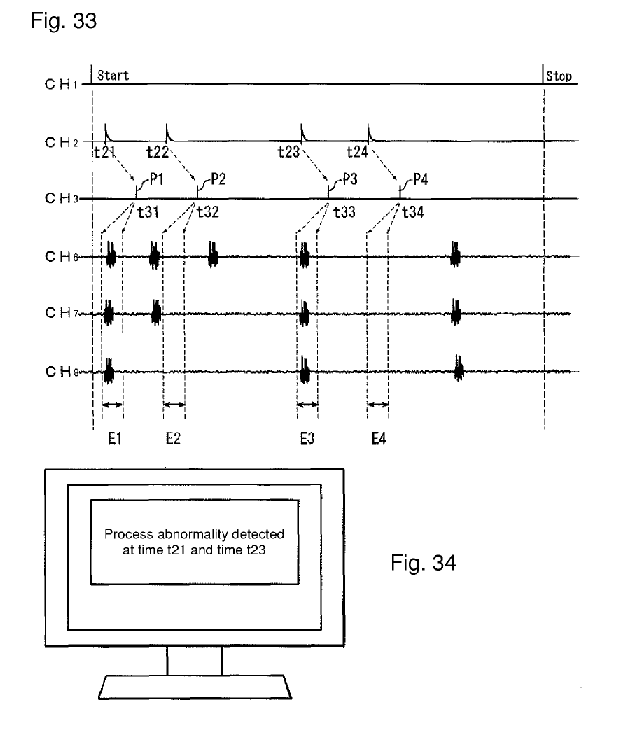

FIG. 33 is a graph showing the first information, the second information, the third information received from the first to the fourth propagating pathways and the cross-correlation function calculated using the first information and the second information. In the graph, the horizontal axis indicates time. Channel (CH) 1 is a signal indicating the start time and the end time of information acquisition.

First, as described in the first embodiment, the first input receiving unit 101 and the second input receiving unit 102 of the information processing device 30 receive the first information and the second information or measurement data outputted from the first propagating pathway. In FIG. 33, CH2 indicates the second information. The window acquiring information is then acquired using the information specifying the period to retrieve using the window function of the first information inputted from the user, and the cross-correlation function with the second information is calculated. By way of example, the portion where abnormality occurred, that is, the portion where peak exists of the first information is retrieved as the window acquiring information using the window function, and the cross-correlation function with the retrieved window acquiring information is calculated.

The third information or the measurement data outputted from the second to the fourth propagating pathway is then received. The normalization process and the filtering process are performed on each third information. The third information received from the second to the fourth propagating pathways is the data of CH6 to CH8 of FIG. 33.

The correlation detecting unit 304 reads out the threshold value for detecting the portion of high correlation of the cross-correlation function prepared in advance from the storage medium or the like (not shown), detects the portion where the value of the cross-correlation function is greater than the threshold value, and acquires the information indicating such a portion such as information of time. CH3 of FIG. 33 is a graph in which the cross-correlation function is binarized with the threshold value for detecting the portion of high correlation. The portion where the value is “H” in the graph is the portion of high correlation. The portion where abnormality occurred or each peak of CH2 corresponds to the portion of high correlation of CH3, that is, the portion where the binarized value is “H”. Specifically, t21 and t31, t22 and t32, t23 and t33, t24 and t34 correspond to each other. The shift of each peak of CH2 and the portion of “H” of the binarized cross-correlation function is due to the delay of when obtaining the cross-correlation function by calculation.

The information determining unit 305 reads out the period specifying information shown in FIG. 32. With respect to the first portion of high correlation detected from the cross-correlation function by the correlation detecting unit 304, the start time and the end time indicating the period for determining the relevance with the third information is calculated using the time at which the rise of the portion of high correlation is detected and the period specifying information. For example, if the time when the first portion of high correlation is detected is t31, t31+ts or the start time of the period for determining relevance and t31+te or the end time are acquired.

The information determining unit 305 then detects the rising edge in the period from t31+ts to t31+te (i.e., period of E1 of FIG. 33) for the third information acquired from the second to the fourth propagating pathways. If the rise of the edge is detected for all third information, a signal indicating that abnormality occurred in all of the second to the fourth propagating pathways in the relevant period with respect to the time at which the signal assuming that the first propagating pathway is abnormal is outputted is outputted. The relevant period is set in advance to the period in which the signal indicating abnormality derived from one cause is assumed to be contained, and thus when the signal indicating that abnormality occurred outputted from each propagating pathway is detected within the relevant period, the signal indicating abnormality is determined as the signal derived from one cause instead of noise or the like individually generated in each propagating pathway. As a result, the abnormality of process is detected. The detection result of the process abnormality is stored in the storage medium (not shown). The detection result stored here may be the information indicating time t21 of the portion corresponding to the portion (portion of time t31) of high correlation detected by the correlation detecting unit 304 of the second information.

Similar process is executed on other portions of high correlation detected from the cross-correlation function by the correlation detecting unit 304.

For example, the peaks P1 to P4 of CH3 in FIG. 33 are the portions of high correlation of the cross-correlation function, as described above, and the regions E1 to E4 corresponding to each portion of high correlation are regions for determining the relevance corresponding to the peaks P1 to P4. With respect to the region E1 and the region E3, the rising edge is detected in the third information acquired from the second to the fourth propagating pathways, that is, in all information of CH6 to CH8, and the information determining unit 305 determines that there is relevance between the signals obtained from all propagating pathways, and detects the occurrence of process abnormality. With respect to the region E2 and the region E4, information in which the rising edge is not detected exists in the information of CH6 to CH8, and thus the information determining unit 305 does not detect the occurrence of abnormality. The determination on relevance is not performed on the information that does not exist in the period for determining relevance of the information from CH6 to CH8, and determination is not made as the information indicating the occurrence of abnormality.

The output unit 307 reads out the information indicating occurrence of abnormality stored by the information determining unit 305 from the storage unit and the like (not shown), and outputs the same.

FIG. 34 is a view showing a display example of the information indicating occurrence of abnormality displayed on the monitor by the output unit 307.

If process abnormality is not detected, notification thereof may be outputted or may not be outputted.

Therefore, according to the present embodiment, the cross-correlation function is calculated using the first information and the second information outputted from the same or different propagating pathways, and whether or not information indicating abnormality of the third information outputted from another propagating pathway exists within the relevant period with respect to the portion determined as having high correlation of the cross-correlation function is determined. In this manner, the relevance of data outputted by different propagating pathways is evaluated, and the abnormality that occurred from one cause in the manufacturing apparatus and the like can be appropriately detected. For example, the information indicating abnormality detected in the non-relevant period of each propagating pathway has a high possibility of being information of noise or the like generated in individual propagating pathway, and thus judgment is not made as abnormal even if such information is detected so that the detection accuracy of abnormality can be enhanced.

The process abnormality is detected from the relevance of the portion indicating that the cross-correlation function has high correlation and the area assumed as abnormal detected from the third information, and thus the cross-correlation function does not need to be calculated for the third information, whereby the calculation time and the like can be reduced and high speed process can be performed.

In each embodiment described above, a case where the information processing device and the manufacturing apparatus 11 are connected through network or the like has been described, but the information processing device may also be arranged in the manufacturing apparatus 11.

In each embodiment described above, each process or each function, may be realized by concentrated processing in a single device, or system, or may be realized by distributed processing by a plurality of devices.

In each embodiment described above, each component maybe configured by a dedicated hardware or the components that can be realized by software may be realized by executing a program. For example, the software program recorded on the recording medium such as a hard disk and a semiconductor memory may be read out and executed by a program executing unit such as a CPU to realize each component.

The software realizing a data display device in each embodiment described above is the following program. Specifically, the program is a program for causing a computer to function as the first input receiving unit for receiving the first information or the time-series data related to the semiconductor process, the second input receiving unit for receiving the second information or the time-series data related to the semiconductor process, the window function processing unit for retrieving the information within a intended period of the first information using a window function and obtaining the window acquiring information, the correlation calculating unit for calculating the cross-correlation function of the window acquiring information retrieved by the window function processing unit and the second information, and the output unit for outputting the information corresponding to the calculation result of the correlation calculating unit.

In the above program, the functions realized by the program do not include the function that can only be realized by hardware. For example, the function that can only be realized by hardware such as a modem and an interface card in the acquiring unit for acquiring information, the output unit for outputting the information, and the like is not included in the functions realized by the program.

The program may be executed by being downloaded from a server or the like, or may be executed when the program recorded in a predetermined recording medium (e.g., optical disc such as CD-ROM, magnetic disc, semiconductor memory, etc.) is read out.

The computer executing such a program may be singular or may be in plurals. In other words, concentrated processing may be performed or distributed processing may be performed.

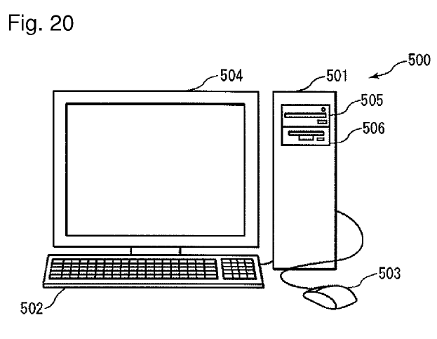

FIG. 20 is a schematic view showing one example of an outer appearance of a computer realizing the data display device according to each embodiment described above. The embodiment is realized by the computer hardware and a computer program executed thereon.

In FIG. 20, a computer system 500 includes a computer 501 with a CD-ROM (Compact Disk Read Only Memory) drive 505 and a FD (Flexible Disk) drive 506, a keyboard 502, a mouse 503, and a monitor 504.

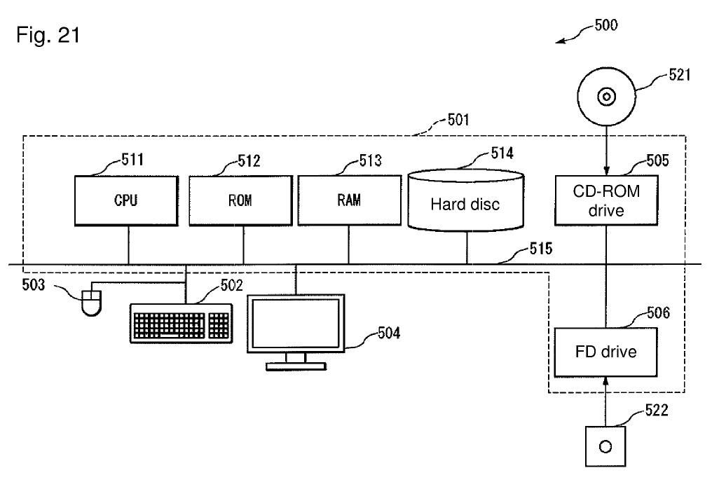

FIG. 21 is a view showing a computer system. In FIG. 21, the computer 501 includes, in addition to the CD-ROM drive 505 and the FD drive 506, a CPU (Central Processing Unit) 511, a ROM (Read Only Memory) 512 for storing program such as a boot up program, a RAM (Random Access Memory) 513, connected to the CPU 511, for temporarily storing a command of the application program and providing a temporary storage space, a hard disk 514 for storing the application program, the system program, and the data, and a bus 515 for mutually connecting the CPU 511, the ROM 512, and the like. The computer 501 may include a network card (not shown) that provides connection to the LAN.

The program for causing the computer system 500 to execute the functions of the data display device according to the embodiment may be stored in a CD-ROM 521 or a FD 522, which are inserted to the CD-ROM drive 505 or the FD drive 506 so that the program is transferred to the hard disk 514. Alternatively, the program may be transmitted to the computer 501 via a network (not shown), and stored in the hard disk 514. The program is loaded in the RAM 513 at the time of execution. The program may be directly loaded from the CD-ROM 521 or the FD 522, or the network.

The program may not necessarily include the operating system (OS), the third party program, or the like for causing the computer 501 to execute the functions of the data display device according to the embodiment. The program may only include a portion of a command for calling out an appropriate function, or module, in a controlled mode so that a desired result can be obtained. How the computer system 500 operates is well known, and thus the detailed description thereof will not be given.

In each embodiment described above, should be recognized that two or more communication means (request information transmission unit, data reception unit, and the like) existing in one device can be physically realized with one medium.

An information processing device according to an embodiment of the present invention includes: a first input receiving unit for receiving first information or time-series data related to a semiconductor process; a second input receiving unit for receiving second information or time-series data related to the semiconductor process; a window function processing unit for retrieving information within a intended period of the first information using a window function, and obtaining window acquiring information; a correlation calculating unit for calculating a cross-correlation function of the window acquiring information retrieved by the window function processing unit and the second information; and an output unit for outputting information corresponding to a calculation result of the correlation calculating unit.

According to such a configuration, a user can accurately detect a state of the semiconductor process. For example, the correlation of only the necessary portion of the first information can be obtained by retrieving the portion indicating a characteristic of the first information and the like with the window function and calculating the cross-correlation function of the retrieved portion and the second information, whereby the state of the semiconductor process can be accurately detected.

Moreover, the information processing device according an embodiment of to the present invention, in the information processing device, further includes: a first normalization processing unit for normalizing the first information, wherein the window function processing unit retrieves the window acquiring information from the first information processed by the first normalization processing unit.

According to such a configuration, the correlation of the first information and the second information can be appropriately obtained, and the state of the semiconductor process can be accurately detected.

Moreover, the information processing device according to an embodiment of the present invention, in the information processing device, further includes: a second normalization processing unit for normalizing the second information, wherein the correlation calculating unit calculates the cross-correlation function of the window acquiring information and the second information processed by the second normalization processing unit.

According to such a configuration, the correlation of the first information and the second information can be appropriately obtained, and the state of the semiconductor process can be accurately detected.

Moreover, the information processing device according to an embodiment of the present invention, in the information processing device, further includes: a first filter unit for performing filtering process on the first information; wherein the window function processing unit retrieves the window acquiring information from the first information processed by the first filter unit.

According to such a configuration, the difference in signal change of the first information and the second information can be absorbed through the filtering process, and the state of the semiconductor process can be accurately detected. For example, the signal change of the first information and the second information caused by the difference in propagating pathway can be absorbed through the filtering process, and the state of the semiconductor process can be accurately detected.

Moreover, the information processing device according to an embodiment of the present invention, in the information processing device, the first filter unit includes at least one of extension filter means for performing extension filter processing, ARX filter means for performing ARX filter processing, envelope filter means, or zero-cross filter means with respect to the first information.

According to such a configuration, the difference in signal change of the first information and the second information can be absorbed through the filtering difference, and the state of the semiconductor process can be accurately detected. For example, the signal change of the first information and the second information caused by the difference in propagating pathway can be absorbed through the filtering process, and the state of the semiconductor process can be accurately detected.

Moreover, the information processing device according to an embodiment of the present invention, in the information processing device, further includes: a second filter unit for performing filtering process on the second information, wherein the correlation calculating unit calculates the cross-correlation function of the window acquiring information and the second information processed by the second filter unit.

According to such a configuration, the difference in signal change of the first information and the second information can be absorbed through the filtering difference, and the state of the semiconductor process can be accurately detected. For example, the signal change of the first information and the second information caused by the difference in propagating pathway can be absorbed through the filtering process, and the state of the semiconductor process can be accurately detected.

Moreover, the information processing device according to an embodiment of the present invention, in the information processing device, the second filter unit includes at least one of extension filter means for performing extension filter processing, ARX filter means for performing ARX filter processing, envelope filter means, or zero-cross filter means with respect to the second information.

According to such a configuration, the difference in signal change of the first information and the second information can be absorbed through the filtering difference, and the state of the semiconductor process can be accurately detected. For example, the signal change of the first information and the second information caused by the difference in propagating pathway can be absorbed through the filtering process, and the state of the semiconductor process can be accurately detected.

Moreover, the information processing device according to an embodiment of the present invention, in the information processing device, further includes: a determining unit for determining whether or not information of high correlation with the window acquiring information is contained in the second information using a calculation result of the correlation calculating unit, and determining whether or not the second information is normal, wherein the output unit outputs a determination result of the determining unit.

According to such a configuration, the determination result on the state of the semiconductor process can be known.

Moreover, the information processing device according to an embodiment of the present invention, in the information processing device, the first input receiving unit and the second input receiving unit receive the first information and the second information outputted for every propagating pathway for a plurality of different propagating pathways; the window function processing unit acquires the window acquiring information for each propagating pathway from the first information outputted from each propagating pathway received by the first input receiving unit; the correlation calculating unit calculates, for the plurality of propagating pathways, the cross-correlation function of the window acquiring information acquired from the first information outputted from one propagating pathway and the second information outputted from the same propagating pathway; the device further includes a correlation detecting unit for detecting a portion of high correlation of the second information and the window acquiring information for each propagating pathway using the cross-correlation function calculated for each propagating pathway by the correlation calculating unit, and a relevance determining unit for determining whether or not the portions of high correlation detected for each propagating pathway by the correlation detecting unit are relevant; and the output unit performs an output corresponding to a determination result of the relevance determining unit.

According to such a configuration, the relevance of different signals of the propagating pathway can be evaluated. For example, whether or not the characteristic portion of different signals of the propagating pathway such as the portion indicating abnormality is a signal derived from the same cause can be recognized. As a result, the characteristic portion of the signal having relevance can be detected from different signals of the propagating pathway, and the state of the semiconductor process can be accurately detected.

Moreover, the information processing device according to an embodiment of the present invention, in the information processing device, the first input receiving unit and the second input receiving unit receive the first information and the second information outputted from the same or different propagating pathways; the device further includes, a third input receiving unit for receiving one or more third information or time-series data outputted from one or more propagating pathways different from the propagating pathway from which the first information and the second information are outputted, a correlation detecting unit for detecting a portion of high correlation of the second information and the window acquiring information using the cross-correlation function calculated by the correlation calculating unit, and an information determining unit for determining whether or not the information indicating abnormality is detected within the relevant period of the third information with respect to the portion of high correlation detected by the correlation detecting unit, and the output unit performs an output corresponding to the determination result of the information determining unit.

According to such a configuration, the relevance of data outputted from different propagating pathways can be evaluated. Thus, the abnormality caused by one cause can be appropriately detected in the semiconductor manufacturing process and the like. For example, since the information indicating abnormality detected in a non-relevant period of each propagating pathway has a high possibility of being information of noise and the like generated in the individual propagating pathway, the detection accuracy of abnormality can be enhanced by not determining such information as abnormal even if detected. As a result, the state of the semiconductor process can be accurately detected.

Moreover, the information processing device according to an embodiment of the present invention, in the information processing device, further includes: a third filter unit for performing filtering process on the third information, wherein the information determining unit determines whether or not information indicating abnormality is detected within a relevant period with respect to the portion of high correlation detected by the correlation detecting unit of the third information processed by the third filter unit.

According to such a configuration, the difference in signal change of the first information and the second information can be absorbed through the filtering process, and the relevance of data outputted from different propagating pathways can be accurately evaluated.

Moreover, the information processing device according to an embodiment of the present invention, in the information processing device, the third filter includes at least one of extension filter means for performing extension filter processing, ARX filter means for performing ARX filter processing, envelope filter means, or zero-cross filter means with respect to the third information.

According to such a configuration, the difference in signal change of the first information and the second information can be absorbed through the filtering process, and the relevance of data outputted from different propagating pathways can be accurately evaluated.

Moreover, the information processing device according to an embodiment of the present invention, in the information processing device, further includes: a designation receiving unit for receiving designation of the intended period of the first information; wherein the window function processing unit retrieves information of the intended period received by the designation receiving unit of the first information using the window function, and obtains window acquiring information.

According to such a configuration, the correlation of only the necessary portion of the first information can be obtained by retrieving the portion specified by the user of the first information such as the portion indicating the characteristic of the first information with the window function and calculating the cross-correlation function of the retrieved portion and the second information, and the state of the semiconductor process can be accurately detected.

According to the information processing device of the embodiment of the present invention, the state of the semiconductor process can be accurately detected from the time-series data related to the semiconductor process.

As mentioned above, the information processing device according to the embodiment of the present invention is applicable to an information processing device for processing time-series data related to a semiconductor process, and in particular, is useful as an information processing device for detecting the state of the manufacturing process from the time-series data.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the U.S. is:

1. An information processing device comprising:
a first input receiving unit configured to receive first information comprising a first time-series data related to a semiconductor process;
a second input receiving unit configured to receive second information comprising a second time-series data related to the semiconductor process;
a window function processing unit configured to retrieve window acquiring information from the first information during a intended period using a window function;
a correlation calculating unit configured to calculate a cross-correlation function between the window acquiring information retrieved by the window function processing unit and the second information; and
an output unit configured to output information corresponding to the cross-correlation function calculated by the correlation calculating unit.

2. The information processing device according to claim 1, further comprising:
a first normalization processing unit configured to normalize the first information,
wherein the window function processing unit retrieves the window acquiring information from the first information normalized by the first normalization processing unit.

3. The information processing device according to claim 1, further comprising:
a second normalization processing unit configured to normalize the second information,
wherein the correlation calculating unit calculates the cross-correlation function between the window acquiring information and the second information normalized by the second normalization processing unit.

4. The information processing device according to claim 1, further comprising:
a first filter unit configured to perform a filtering process on the first information,
wherein the window function processing unit retrieves the window acquiring information from the first information processed by the first filter unit.

5. The information processing device according to claim 4, wherein the first filter unit comprises at least one of an extension filter configured to perform extension filter processing, an ARX filter configured to perform ARX filter processing, an envelope filter, and a zero-cross filter with respect to the first information.

6. The information processing device according to claim 1, further comprising:
a second filter unit configured to perform a filtering process on the second information,
wherein the correlation calculating unit calculates the cross-correlation function between the window acquiring information and the second information processed by the second filter unit.

7. The information processing device according to claim 6, wherein the second filter unit comprises at least one of an extension filter configured to perform extension filter processing, an ARX filter configured to perform ARX filter processing, an envelope filter, and a zero-cross filter with respect to the second information.

8. The information processing device according to claim 1, further comprising:
a determining unit configured to determine whether or not the second information contains information having a high correlation with the window acquiring information, and to determine whether or not the second information is normal,
wherein the output unit outputs a determination result of the determining unit.

9. The information processing device according to claim 1, further comprising:
a correlation detecting unit; and
a relevance determining unit,
wherein each of the first information and the second information contains information outputted via a first propagating pathway and information outputted via a second propagating pathway,
wherein the window function processing unit retrieves the window acquiring information with respect to each of the first and second propagating pathways,
wherein the correlation calculating unit calculates the cross-correlation function between the window acquiring information and the second information with respect to each of the first and second propagating pathways,
wherein the correlation detecting unit is configured to detect the high correlation portion between the second information and the window acquiring information with respect to each of the first and second propagating pathways using the cross-correlation function calculated for each propagating pathway by the correlation calculating unit,
wherein the relevance determining unit is configured to determine whether or not the high correlation portion detected with respect to the first propagating pathway is relevant to the high correlation portion detected with respect to the second propagating pathway, and
wherein the output unit outputs information corresponding to a determination result of the relevance determining unit.

10. The information processing device according to claim 1, further comprising:
a third input receiving unit configured to receive at least one third information comprising a third time-series data outputted via at least one propagating pathway different from a propagating pathway via which at least one of the first information and the second information is outputted;
a correlation detecting unit configured to detect a high correlation portion between the second information and the window acquiring information using the cross-correlation function calculated by the correlation calculating unit; and
an information determining unit configured to determine whether or not abnormality is detected within a period of the at least one third information, corresponding to the high correlation portion detected by the correlation detecting unit, and
wherein the output unit outputs information corresponding to a determination result of the information determining unit.

11. The information processing device according to claim 10, further comprising:
a third filter unit configured to perform a filtering process on the at least one third information,
wherein the information determining unit determines whether or not abnormality is detected within the at least one third information processed by the third filter unit.

12. The information processing device according to claim 11, wherein the third filter comprises at least one of an extension filter configured to perform extension filter processing, an ARX filter configured to perform ARX filter processing, an envelope filter, and a zero-cross filter with respect to the at least one third information.

13. The information processing device according to claim 1, further comprising:
a designation receiving unit configured to receive a designation of the intended period of the first information,
wherein the window function processing unit retrieves the window acquiring information from the first information during the intended period corresponding to the designation received by the designation receiving unit.

14. An information processing method comprising:
receiving first information comprising a first time-series data related to a semiconductor process;
receiving second information comprising a second time-series data related to the semiconductor process;
retrieving window acquiring information from the first information during a intended period using a window function;
calculating a cross-correlation function between the window acquiring information and the second information; and
outputting information corresponding to the cross-correlation function.

15. A program configured to cause a computer to perform a process comprising:
receiving first information comprising a first time-series data related to a semiconductor process;
receiving second information comprising a second time-series data related to the semiconductor process;
retrieving window acquiring information from the first information during a intended period using a window function;
calculating a cross-correlation function between the window acquiring information and the second information; and
outputting information corresponding to the cross-correlation function.

16. An information processing device comprising:
means for receiving first information comprising a first time-series data related to a semiconductor process;
means for receiving second information comprising a second time-series data related to the semiconductor process;
means for retrieving window acquiring information from the first information during a intended period using a window function;
means for calculating a cross-correlation function between the window acquiring information and the second information; and
means for outputting information corresponding to the cross-correlation function.
